(19) United States
(12) Patent Application Publication
(10) Pub. No.: US 2008/0227002 A1
(43) Pub. Date: Sep. 18, 2008

(54) TONER, DEVELOPER, AND IMAGE FORMING METHOD

(76) Inventors: Yoshihiro Moriya, Numazu-shi (JP); Hiroshi Yamashita, Numazu-shi (JP); Akihiro Kotsugai, Numazu-shi (JP); Shinya Nakayama, Numazu-shi (JP); Tsuyoshi Sugimoto, Mishima-shi (JP); Akiyoshi Sabu, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/048,741

(22) Filed: Mar. 14, 2008

(30) Foreign Application Priority Data
Mar. 16, 2007 (JP) 2007-069546

(51) Int. Cl. G03G 13/14; G03G 9/087

(52) U.S. Cl. 430/48; 430/109.4

(57) ABSTRACT

To provide a toner including a binder resin and colorant and is granulated in aqueous medium, wherein the binder resin is a polymer having a polyester skeleton, the polyester skeleton is obtained by block copolymerization of a polyester skeleton A in which at least a constituent unit in which CH₃—C*—H(—OH)(COOH) is dehydration condensed is contained in a repeated structure and a polyester skeleton B in which a constituent unit in which CH₃—C*—H(—OH)(COOH) is dehydration condensed is not contained in a repeated structure, and an optical isomer ratio X (%) (monomer equivalent) is 80% or less, where the optical isomer ratio X (%)=|X (L-type)−X (D−type)| where X (L-type) denotes a ratio (%) of L-type (lactic acid monomer equivalent) and X (D-type) denotes a ratio (%) of D-type (lactic acid monomer equivalent)) in the constituent unit where CH₃—C*—H(—OH)(COOH) is dehydration condensed.

### BACKGROUND OF THE INVENTION

1. Field of the Invention

The present invention relates to a toner for use in image forming apparatus using an electrostatic copying process such as copying machines, facsimiles and printers, a developer using the toner, and an image forming method using the toner.

2. Description of the Related Art

In electrophotographic apparatuses and electrostatic recording apparatuses, electric or magnetic latent images are developed into images by the use of toner. For example, in an electrophotographic process, an electrostatic image or latent image is formed on a photoconductor, and then the latent image is developed by use of toner to form a toner image. Typically, the toner image is transferred onto a transfer material such as paper and then fixed thereto by means of heating or the like.

A toner used for developing a latent electrostatic image is generally colored particles in which a colorant, charge controlling agent and other additives are contained in a binder resin. There are two types of method for producing such a toner, namely, pulverization methods and suspension polymerization methods. In the pulverization method, colorants, charge controlling agents, anti-offset agents, and the like are melted and mixed to be uniformly dispersed in a thermoplastic resin, and the obtained composition is crushed and classified to thereby produce a toner. According to the pulverization method, it is possible to produce a toner having excellent properties to some extent, however, there are limitations on selection of toner materials. For example, a composition produced by melting and mixing toner materials are required to be crushed and classified by using an economically available apparatus. To respond to the request, the melted and mixed component is forced to be made sufficiently brittle. For this reason, when the composition is actually pulverized into particles, a broad particle size distribution is liable to be formed. When a copied image having excellent resolution and gradation is expected to be obtained, for example, it suffers from the disadvantages that fine particles each having a particle diameter of 5 μm or less and fine particles each having a particle diameter of 20 μm or more must be eliminated by classifying the toner particles, and the yield is substantially low. In addition, in the pulverization method, it is hard to uniformly disperse colorants and charge controlling agents, and the like in a thermoplastic resin. A dispersion liquid in which components are insufficiently dispersed adversely affects flowability of a toner, developing property, durability, image quality, and the like.

On the other hand, a dissolution suspension method for preparing a toner has been proposed in Japanese Patent (JP-B) Nos. 3344214 and 3455523. In the dissolution suspension method, a resin solution in which a resin, which has previously been prepared from a polymerization reaction, is dissolved in a solvent is dispersed in an aqueous medium including a dispersing agent or a dispersing assisting agent (such as a surfactant and a water-soluble resin), dispersion stabilizer such as inorganic fine particles or resin fine particles, and then the solvent is removed upon application of heat or under reduced pressure to prepare toner particles. According to this method, it is possible to obtain particles having a uniform diameter without the classification process.

In an image forming apparatus of an electrophotographic system, a toner is required to have releasing property (hereinafter referred to as hot offset resistance) in that the toner is separated from a heating member such as a heat roller in a fixing process using a contact heating method. In attempting to improve hot offset resistance, JP-B No. 3640918 discloses a toner including a modified polyester resin prepared by reacting a precursor of the polyester resin, prepared by a dissolution suspension method.

A toner typically includes a binder resin in an amount of 70% or more. Since most of the conventional binder resins are made from oil resources, there are concerns of depletion of the oil resources and the issue of global warming caused by discharge of a carbon dioxide gas into the air due to heavy consumption of the oil resources. If a binder resin can be synthesized from a plant which grows by utilizing carbon dioxide gas in the air, the carbon dioxide gas can be circulated. Namely, there is a possibility of preventing the global warming and the depletion of the oil resources. Therefore, polymers derived from plant resources (i.e., biomass) are receiving attention recently.

In attempting to use polymers derived from plant resources as a binder resin, JP-B No. 2909873 discloses a toner including polylactic acid as a binder resin. However, since polylactic acids have ester groups at a higher concentration compared to polyester resins, the polylactic resin has too high a thermal property to serve as a thermoplastic resin when the toner is fixed. In addition, because of having too high a hardness, the polylactic resin cannot be used for pulverized toners.

Japanese Patent Application Laid-Open (JP-A) No. 09-274335 discloses a toner including a polyester resin formed by a dehydration polycondensation reaction between lactic acid and oxycarboxylic acid having 3 or more functional groups. However, since the polyester resin formed by a dehydrate polycondensation reaction between an alcohol group of the lactic acid and carboxylic acid group of the oxycarboxylic acid has high molecular weight, sharp-melting property and low temperature fixability of the toner are impaired.

Further, to improve the thermal property, JP-B No. 3785011 proposes that terpene phenol copolymer is included as a low molecular weight component in polylactic acid type biodegradable resin. However, this proposal cannot simultaneously satisfy both the low temperature fixability and hot offset resistance. As mentioned above, a toner using polylactic acid resin does not still come into practical use.

The toners disclosed in the above related art are obtained by a pulverization method and thus suffer from toner loss caused by classification and problem of disposal involving the toner loss. Another problem is that a comparatively large amount of energy is required for the pulverization method. Thus, there remains a need to use toner prepared in an aqueous system (or polymerization toner) for further reduced environmental loads.

The polylactic acid which is used widely as a plant-based polymer and is easily-available is, as disclosed in JP-B No. 3347406 and JP-A No. 59-96123, synthesized by dehydration condensation of lactic acid monomer or ring-opening polymerization of a cyclic lactide of lactic acid. Therefore, in manufacturing a toner using the polylactic acid in an aqueous medium, not a narrowly-defined polymerized toner obtained by polymerization in an aqueous medium, but aqueous medium toner particles can be obtained by a method using an organic solvent, as disclosed in JP-B Nos. 3344214, 3455523, and 3640918.

However, the polylactic acid made by polymerization of a single monomer has a high crystallinity, so that the solubility thereof into an organic solvent is extremely low, thus making it difficult to use the abovementioned method in which particles are formed in an aqueous medium after being dissolved in the organic solvent.

In order to increase the solubility, not only one of enantiomers (L-type and D-type) constituting the polylactic acid is used, but also the other enantiomer is mixed to alter the L/D ratio to decrease the crystallinity, resulting in an increase in the solubility into the organic solvent.

On the other hand, it is difficult to control the molecular weight of the polylactic acid itself and, further, a molecular chain forming the ester bond contains only carbon atoms (N=1). Thus, it is difficult to achieve physical property required in the toner only with the polylactic acid.

It can be considered that the polylactic acid and another resin are mixed together to ensure the physical property and thermal property required in the toner. However, the polylactic acid has extremely poor compatibility with, and dispersibility in a polyester resin and styrene-acrylic copolymer, which are generally used for toner, irrespective of whether the solubility between the polylactic acid by itself and organic solvent is excellent or poor. Thus, it is now very difficult to produce a toner by combining the polylactic acid and another resin.

### BRIEF SUMMARY OF THE INVENTION

An object of the present invention is to provide a toner capable of achieving high image density and simultaneously satisfying both the fixability and storage stability even when a resin containing a polylactic acid as a constituent is used as a binder resin, and developer using the toner, as well as an image forming method.

As a result of the present inventor's earnest studies to solve the above problem, it has been found that it is possible to significantly increase the solubility of a first binder resin containing polylactic acid as a constituent into an organic resin, which is required in particle formation in an aqueous medium, by setting a ratio between L-type and D-type constituting the polylactic acid to a specific value or by combining a second binder resin with the first resin in a specific ratio in the case where the first resin alone cannot satisfactorily be dissolved into the organic resin. Further, it has found that by using a block polymer containing as a constituent the polylactic acid and polyester not including the polylactic acid as the first binder resin, it is possible to simultaneously satisfy both the fixability and storage stability of the toner, as well as to increase the compatibility with the second binder resin, obtaining a uniform resin composition in the toner, which enables a stable image to be output.

The present invention has been accomplished based on the above findings obtained by the inventors of the present invention, and means for solving the problems are as follows.

<1> A toner including: a binder resin and a colorant, the toner prepared in an aqueous medium, wherein the binder resin is a polymer having a polyester skeleton, the polyester skeleton of the polymer is obtained by block copolymerization of a polyester skeleton A in which at least a constituent unit in which CH₃—C*—H(—OH)(COOH) is dehydration condensed is contained in a repeated structure and a polyester skeleton B in which a constituent unit in which CH₃—C*—H(—OH)(COOH) is dehydration condensed is not contained in a repeated structure, and an optical isomer ratio X (%) (monomer equivalent) is 80% or less, where the optical isomer ratio X (%)=|X (L-type)−X (D-type)| where X (L-type) denotes a ratio (%) of L-type (lactic acid monomer equivalent) and X (D-type) denotes a ratio (%) of D-type (lactic acid monomer equivalent)) in the constituent unit in which CH₃—C*—H(—OH)(COOH) is dehydration condensed.

<2> A toner including: a binder resin and a colorant, the toner prepared in an aqueous medium, wherein the binder resin contains a first binder resin composed of a polymer having a polyester skeleton and a second binder resin, the first binder resin is obtained by block copolymerization of a polyester skeleton A in which at least a constituent unit in which CH₃—C*—H(—OH)(COOH) is dehydration condensed is contained in a repeated structure and a polyester skeleton B in which a constituent unit in which CH₃—C*—H(—OH)(COOH) is dehydration condensed is not contained in a repeated structure, and a weight ratio Y % of the first binder resin in all binder resin components and an optical isomer ratio X (%) (monomer equivalent) satisfy the following conditions: Y≦−1.5X+220, 80<X≦100, where the optical isomer ratio X (%)=|X (L-type)−X (D-type)| where X (L-type) denotes a ratio (%) of L-type (lactic acid monomer equivalent) and X (D-type) denotes a ratio (%) of D-type (lactic acid monomer equivalent)) in the constituent unit in which CH₃—C*—H(—OH)(COOH) constituting the first binder resin is dehydration condensed.

<3> The toner according to any one of <1> and <2>, wherein the weight ratio of the polyester skeleton A in the binder resin is 20% or more and less than 80%.

<4> The toner according to any one of <1> to <3>, wherein the binder resin which is a block copolymer of the polyester skeleton A and polyester skeleton B is obtained by ring-opening polymerization of cyclic ester.

<5> The toner according to any one of <1> to <4>, wherein the binder resin contains a modified polyester resin reactive with an active hydrogen group-containing compound.

<6> The toner according to <5>, wherein the modified polyester resin reactive with the active hydrogen group-containing compound is a modified polyester resin having an isocyanate group at its terminal.

<7> The toner according to any one of <1> to <6>, wherein reaction at the time of particle formation is one of urea reaction and urethane reaction.

<8> The toner according to any one of <5> to <7>, wherein the weight ratio of the modified polyester resin reactive with the active hydrogen group-containing compound relative to all the binder resin components constituting the toner is 5% by mass to 30% by mass.

<9> The toner according to any one of <1> to <8>, wherein the glass transition temperature of the binder resin containing the polyester resin and modified polyester resin is 40° C. or more and 70° C. or less.

<10> The toner according to any one of <1> to <9>, wherein the volume average particle diameter of the toner is 3 μm to 8 μm.

<11> The toner according to any one of <1> to <10>, wherein a ratio of the number average particle diameter (Dn) to the volume average molecular weight (Dv) of the toner, Dn/Dv, is 1.00 to 1.25.

<12> A developer including: the toner according to any one of <1> to <11> and a carrier.

<13> An image forming method including: forming a latent electrostatic image on a latent electrostatic image bearing member; developing the latent electrostatic image to form a visible image using a toner; transferring the visible image onto a recording medium; and fixing the visible image to the recording medium, wherein the toner the toner according to any one of <1> to <11>.

In a first embodiment, a toner according to the present invention contains at least a binder resin and a colorant and is generated in an aqueous medium, wherein the binder resin is a polymer having a polyester skeleton, the polyester skeleton of the polymer is obtained by block copolymerization of a polyester skeleton A in which at least a constituent unit in which CH₃—C*—H(—OH) (COOH) is dehydration condensed is contained in a repeated structure and a polyester skeleton B in which a constituent unit in which CH₃—C*—H(—OH)(COOH) is dehydration condensed is not contained in a repeated structure, and an optical isomer ratio X (%) (monomer equivalent) is 80% or less, where the optical isomer ratio X (%)=|X (L-type)−X (D-type)| where X (L-type) denotes a ratio (%) of L-type (lactic acid monomer equivalent) and X (D-type) denotes a ratio (%) of D-type (lactic acid monomer equivalent)) in the constituent unit in which CH₃—C*—H(—OH)(COOH) is dehydration condensed.

In a second embodiment, a toner according to the present invention contains at least a binder resin and a colorant and is generated in an aqueous medium, wherein the binder resin contains a first binder resin composed of a polymer having a polyester skeleton and a second binder resin, the first binder resin is obtained by block copolymerization of a polyester skeleton A in which at least a constituent unit in which CH₃—C*—H(—OH)(COOH) is dehydration condensed is contained in a repeated structure and a polyester skeleton B in which a constituent unit in which CH₃—C*—H(—OH)(COOH) is dehydration condensed is not contained in a repeated structure, and a relationship between the weight ratio Y % of the first binder resin in all binder resin components and the optical isomer ratio X (%) (monomer equivalent)=|X (L-type)−X (D-type)| (where X (L-type) denotes a ratio (%) of L-type (lactic acid monomer equivalent) and X (D-type) denotes a ratio (%) of D-type (lactic acid monomer equivalent)) in the constituent unit in which CH₃—C*—H(—OH)(COOH) constituting the first binder resin is dehydration condensed satisfies the following conditions: Y≦−1.5X+220, 80<X≦100.

In the first and second embodiments, a binder resin obtained by block copolymerization of a polyester A containing, as a constituent unit, polylactic acid and polyester B not containing polylactic acid is used in a toner formed in an aqueous medium to thereby increase organic solvent solubility required in the particle formation in an aqueous medium. Further, combined use of the polyester B or second binder resin can reduce adverse affect of a polylactic acid skeleton on toner physical properties, thereby ensuring toner basic performance. Further, by using a developer containing the toner, it is possible to obtain stable image density and excellent fixability over a long period of time.

### BRIEF DESCRIPTION OF THE SEVERAL VIEWS OF THE DRAWINGS

FIG. 1 is a view schematically showing an example of a process cartridge used in the present invention;

FIG. 2 is a view schematically showing an example of an image forming apparatus used in an image forming method according to the present invention;

FIG. 3 is a view schematically showing another example of the image forming apparatus used in an image forming method according to the present invention;

FIG. 4 is a view schematically showing an example of a tandem type color image forming apparatus used in an image forming method according to the present invention; and

FIG. 5 is a partially enlarged view schematically showing a part of the image forming apparatus of FIG. 4.

### DETAILED DESCRIPTION OF THE INVENTION

(Toner)

A toner of the present invention is produced in an aqueous medium; it includes at least a binding resin and a colorant, and it further includes other components according to requirements.

In a first embodiment, the binder resin is composed of a polymer having a polyester skeleton. The polyester skeleton of the polymer is obtained by block copolymerization of a polyester skeleton A in which at least a constituent unit in which CH₃—C*—H(—OH)(COOH) is dehydration condensed is contained in a repeated structure and a polyester skeleton B in which a constituent unit in which CH₃—C*—H(—OH)(COOH) is dehydration condensed is not contained in a repeated structure.

The optical isomer ratio X (%) (monomer equivalent) is preferably 80% or less and, more preferably, 60% or less, the optical isomer ratio X (%) being |X (L-type)−X (D-type)| where X (L-type) denotes a ratio (%) of L-type (lactic acid monomer equivalent) and X (D-type) denotes a ratio (%) of D-type (lactic acid monomer equivalent)) in the constituent unit in which CH₃—C*—H(—OH)(COOH) is dehydration condensed. When the optical isomer ratio X (%) exceeds 80%, which means the ratio of one optical isomer is too high, the crystallinity in the polylactic acid skeleton significantly increases, with the result that the solubility into an organic resin, which is required in particle formation in an aqueous medium is significantly impaired.

In a second embodiment, the binder resin includes a first binder resin composed of a polymer having a polyester skeleton and a second binder resin. The first binder resin is obtained by block copolymerization of a polyester skeleton A in which at least a constituent unit in which CH₃—C*—H(—OH)(COOH) is dehydration condensed is contained in a repeated structure and a polyester skeleton B in which a constituent unit in which CH₃—C*—H(—OH)(COOH) is dehydration condensed is not contained in a repeated structure.

A relationship between the weight ratio Y % of the first binder resin in all binder resin components and the optical isomer ratio X (%) (monomer equivalent)=|X (L-type)−X (D-type)| (where X (L-type) denotes a ratio (%) of L-type (lactic acid monomer equivalent) and X (D-type) denotes a ratio (%) of D-type (lactic acid monomer equivalent)) in the constituent unit in which CH₃—C*—H(—OH)(COOH) constituting the first binder resin is dehydration condensed satisfies the following conditions: Y≦−1.5X+220, 80<X≦100.

In the second embodiment, the combined use of the first and second binder resins allows a flexible design of resin characteristics, which is required for a toner and which cannot be achieved only with the polyester skeleton A constituting the first binder resin of the first embodiment. Thus, for example, poor low temperature fixability of the polyester skeleton A can be improved by adding the second binder resin exhibiting excellent low temperature fixability.

Further, the combined used of the first and second binder resins increases the organic solvent solubility required in the particle formation in an aqueous medium in the case where the relationship between the weight ratio Y % of the first binder resin in all binder resin components and the optical isomer ratio X (%) (monomer equivalent)=|X (L-type)−X (D-type)| (where X (L-type) denotes a ratio (%) of L-type (lactic acid monomer equivalent) and X (D-type) denotes a ratio (%) of D-type (lactic acid monomer equivalent)) in the constituent unit in which CH₃—C*—H(—OH)(COOH) constituting the first binder resin is dehydration condensed satisfies the following conditions: Y≦−1.5X+220, 80<X≦100.

In the case where only the first binder resin is used as a toner binder resin without use of the second binder resin as in the case of the first embodiment, the optical isomer ratio X (%), that is |X (L-type)−X (D-type)| where X (L-type) denotes a ratio (%) of L-type (lactic acid monomer equivalent) and X (D-type) denotes a ratio (%) of D-type (lactic acid monomer equivalent)) in the polyester skeleton A, needs to be 80% or less.

However, as a result of the present inventor's earnest studies, it has been found that even in the case where 80<X (optical isomer ratio (%))≦100, the organic solvent solubility of the first binder resin is significantly increased by the combined use of the second binder resin with the first binder resin in a specific ratio. The reason for this is not clear, but it can be considered that the compatibility between the polyester skeleton B of the first binder resin and second binder resin may reduce the high crystallinity of the polyester skeleton A block-copolymerized with the polyester skeleton B.

When the value of Y exceeds −1.5X+220, the solubility-increasing effect of the first binder resin achieved by the use of the second binder resin is impaired to form an insoluble state in the organic solvent.

The method of measuring the optical isomer ratio X is not particularly limited and any method can be employed according to the intended purpose. For example, the optical isomer ratio X can be found in the following manner. A polymer or toner that has a polyester skeleton is added to a mixture solvent consisting of pure water, 1 mol/l sodium hydroxide solution and isopropyl alcohol. The mixture is then heated to 70° C. and stirred for hydrolysis, followed by filtration for removal of solids and by addition of sulfuric acid for neutralization to give an aqueous solution containing L-lactic acid and/or D-lactic acid that have been produced by decomposition of the polyester. The aqueous solution is subjected to high-performance liquid chromatography (HPLC) on a Sumichiral OA-5000 column, a chiral ligand-exchange column available from Sumika Chemical Analysis Service, Ltd., Japan, to obtain both the peak area S (L) derived from L-lactic acid and peak area S (D) derived from D-lactic acid. Using these peak areas it is possible to find the optical isomer ratio X as follows:

X(L-type) %=100×S(L)/(S(L)+S(D))

X(D-type) %=100×S(D)/(S(L)+S(D))

Optical isomer ratio X%=|X(L-type) %−X(D-type) %|

The binder resin according to the first embodiment is composed of a polymer having a polyester skeleton. The polyester skeleton of the polymer is obtained by block copolymerization of a polyester skeleton A in which at least a constituent unit in which CH₃—C*—H(—OH)(COOH) is dehydration condensed is contained in a repeated structure and a polyester skeleton B in which a constituent unit in which CH₃—C*—H(—OH)(COOH) is dehydration condensed is not contained in a repeated structure.

The binder resin can be obtained by ring-opening addition polymerization of cyclic ester constituting the skeleton A and a product obtained, as the polyester skeleton B, by a polyesterification reaction between one kind or two or more kinds of polyols represented by the following general formula (1) and one kind or two or more kinds of polycarboxylic acids represented by the following general formula (2).

A-(OH)m general formula (1)

In the general formula (1), A represents an alkyl group having 1 to 20 carbon atoms, an alkylene group having 1 to 20 carbon atoms, or an aromatic group or heterocyclic aromatic group which may have a substituent group. m represents an integer of 2 to 4.

B—(COOH)n general formula (2)

In the general formula (2), B represents an alkyl group having 1 to 20 carbon atoms, an alkylene group having 1 to 20 carbon atoms, or an aromatic group or heterocyclic aromatic group which may have a substituent group. n represents an integer of 2 to 4.

Specific examples of the cyclic ester include, but are not limited to, any compounds capable of producing a polyester by a ring-opening addition polymerization. In particular, L-lactide, D-lactide, DL-lactide, racemic lactide, glycoside, γ-butyrolactone, 6-valerolactone, and ε-caprolactone are preferably used because these compounds can be obtained easily. These compounds may be used alone or in combination of two or more.

Specific examples of polyols represented by the general formula (1) include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentane triol, glycerol, 2-methylpropane triol, 2-methyl-1,2,4-butane triol, trimethylol ethane, trimethylol propane, 1,3,5-trihydroxymethyl benzene, bisphenol A, bisphenol A ethylene oxide adducts, bisphenol A propylene oxide adducts, hydrogenated bisphenol A, hydrogenated bisphenol A ethylene oxide adducts, and hydrogenated bisphenol A propylene oxide adducts. These may be used alone or in combination of two or more.

Specific examples of polycarboxylic acids represented by the general formula (2) include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isooctyl succinic acid, isododecenylsuccinic acid, n-dodecylsuccinic acid, isododecylsuccinic acid, n-octenyl succinic acid, n-octyl succinic acid, isooctenyl succinic acid, isooctyl succinic acid, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Empol trimer acid, cyclohexanedicarboxylic acid, cyclohexenedicarboxylic acid, butanetetracarboxylic acid, diphenylsulfonetetracarboxylic acid, and ethylene glycol bis(trimellitic acid). These may be used alone or in combination of two or more.

The weight ratio of the polyester skeleton A in the binder resin is preferably 20% or more and 80% or less and, more preferably 20% or more and 50% or less. When the weight ratio is less than 20%, which means that the ratio of a plant-derived resin component in the toner is low, biomass effect becomes insufficient. On the other hand, when the weight ratio exceeds 80%, the low temperature fixability may deteriorate by the characteristics of the polylactic acid.

In the second embodiment, the binder resin includes a first binder resin composed of a polymer having a polyester skeleton and a second binder resin.

The first binder resin is the same as the binder resin mentioned in the above first embodiment.

The second binder resin is not particularly limited and may be suitably selected according to the purpose. Specific examples of the second binder resin include polyester resin, silicone resin, styrene-acrylic resin, styrene resin, acrylic resin, epoxy resin, diene-based resin, phenol resin, terpene resin, coumarin resin, amide resin, amide imide resin, butyral resin, urethane resin, and ethylene vinyl acetate resin. Among these compounds, polyester resin is particularly preferable because of being sharply melted in fixing time, being capable of smoothing the image surface, being excellent in the compatibility with the first binder resin, having sufficient flexibility even if the molecular weight thereof is lowered. A combination of another resin with the polyester resin may be made.

As the polyester resin, a product obtained by a polyesterification reaction between one kind or two or more kinds of polyols represented by the following general formula (1) and one kind or two or more kinds of polycarboxylic acids represented by the following general formula (2).

A-(OH)m general formula (1)

In the general formula (1), A represents an alkyl group having 1 to 20 carbon atoms, an alkylene group having 1 to 20 carbon atoms, or an aromatic group or heterocyclic aromatic group which may have a substituent group. m represents an integer of 2 to 4.

B—(COOH)n general formula (2)

In the general formula (2), B represents an alkyl group having 1 to 20 carbon atoms, an alkylene group having 1 to 20 carbon atoms, or an aromatic group or heterocyclic aromatic group which may have a substituent group. n represents an integer of 2 to 4.

As the compounds represented by the general formulas (1) and (2), those same as the first embodiment are used.

<Modified Polyester Resin Reactive with Active Hydrogen Group-Containing Compound>

The binder resin may contain at least a modified polyester resin reactive with an active hydrogen group-containing compound.

—Active Hydrogen Group-Containing Compound—

The active hydrogen group-containing compound functions as an elongation initiator or crosslinking agent at the time of elongation reaction or crosslinking reaction with the polyester reactive with the active hydrogen group-containing compound in aqueous medium.

The active hydrogen group-containing compounds may be anything as long as containing active hydrogen group, and may suitably be selected according to the purpose. For example, in cases where the modified polyester reactive with the active hydrogen group-containing compounds is an isocyanate group-containing modified polyester (A), amines (B) are preferable from the viewpoint of ability to increase molecular weight by the elongation reaction or crosslinking reaction.

The active hydrogen group may be suitably selected according to the purpose; examples thereof include hydroxyl group such as alcoholic hydroxyl group and phenolic hydroxyl group, amino group, carboxyl group and mercapto group. These may be used alone or in combination of two or more. Among these, alcoholic hydroxyl group is particularly preferable.

The amines (B) may be suitably selected according to the purpose; examples thereof include diamines (B1), polyamines of trivalent or higher (B2), amino alcohols (B3), amino mercaptans (B4), amino acids (B5), and blocked ones (B6) of amino groups (B1) to (B5).

These may be used alone or in combination of two or more. Among these, diamines (B1), and mixtures of diamines (B1) and a small amount of polyamines of trivalent or higher (B2) are particularly preferable.

Examples of diamines (B1) include aromatic diamines, alicyclic diamines and aliphatic diamines. Examples of aromatic diamine are phenylene diamine, diethyltoluene diamine and 4,4′-diaminophenylmethane. Examples of alicyclic diamine include 4,4′-diamino-3,3′-dimethyldicycrohexylmethane, diamine cyclohexane and isophorone diamine. Examples of aliphatic diamine include ethylene diamine, tetramethylene diamine and hexamethylene diamine.

Examples of polyamines of trivalent or higher (B2) include diethylene triamine and triethylene tetramine.

Examples of amino alcohols (B3) include ethanolamine and hydroxyethylaniline.

Examples of amino mercaptans (B4) include aminoethylmercaptan and aminopropylmercaptan.

Examples of amino acids (B5) include amino propionic acid and aminocaproic acid.

Examples of compounds (B6) with blocked amino groups (B1) to (B5) include ketimine compounds and oxazoline compounds, obtained from amines, and ketones such as acetone, methyl ethyl ketone and methyl isobutyl ketone.

A reaction terminator may be used to stop the elongation reaction, crosslinking reaction, or the like between the active hydrogen group-containing compound and the modified polyester reactive with the compound. The reaction terminator is preferably employed for controlling the molecular weight of adhesive base material within a preferable range. Examples of reaction terminator include monoamines such as diethylamine, dibutylamine, butylamine and laurylamine, and also block compounds thereof such as ketimine compounds.

The mixture ratio of amines (B) and the isocyanate group-containing modified polyester (A), in terms of mixture equivalent ratio of isocyanate group [NCO] in the isocyanate group-containing modified polyester (A) and amino group [NHx] in the amines (B), [NCO]/[NHx], is preferably from 1/3 to 3/1, more preferably from 1/2 to 2/1 and particularly preferably from 1/1.5 to 1.5/1.

When the mixture equivalent ratio [NCO]/[NHx] is less than ⅓, the low-temperature fixability may deteriorate, and when it is more than 3/1, the molecular weight of modified polyester becomes low, possibly impairing the hot offset resistance.

—Modified Polyester Resin—

The site of the modified polyester resin reactive with the active hydrogen group-containing compound (hereinafter sometimes referred to as “polyester prepolymer”) may be suitably selected from publicly known substituents; examples thereof include isocyanate group, epoxy group, carboxylic acid, acid chloride group, and the like. These may be used alone or in combination of two or more. Among these, isocyanate group is particularly preferable.

Among the modified polyesters described above, urea-bond-forming group containing polyester resins (RMPE) are particularly preferable, in view of controllable molecular weight of their polymers, oilless-fixability of dry toner at low temperatures, in particular favorable releasability and fixability even without release-oil-coating system for fixing-heating medium.

The urea-bond-forming group is exemplified by an isocyanate group. In cases where the urea-bond-forming group of the urea-bond-forming group containing polyester resins (RMPE) is isocyanate group, the polyester resins (RMPE) are preferably exemplified by the isocyanate group-containing polyester prepolymers (A).

The skeleton of the isocyanate group-containing polyester prepolymer (A) may be suitably selected according to the purpose; examples thereof include a reactant of the active hydrogen group-containing polyester which is a polycondensation product of polyol (PO) and polycarboxylic acid (PC) and a polyisocyanate (PIC) and a reactant of the active hydrogen group-containing polyester obtained by ring-opening addition polymerization of a polycondensation product of polyol (PO) and polycarboxylic acid (PC) and cyclic ester and a polyisocyanate (PIC).

The polyol (PO) may be suitably selected according to the purpose; examples thereof include diols (DIO), polyols (TO) of trivalent or higher, mixtures of diols (DIO) and polyols (TO) of trivalent or higher, and the like. These may be used alone or in combination of two or more. Among these, diols (DIO) alone and mixtures of diols (DIO) and a small amount of polyols (TO) of trivalent or higher are preferable.

Examples of diols (DIO) include alkylene glycols, alkylene ether glycols, alicyclic diols, alkylene oxide adducts of alicyclic diols, bisphenols, alkylene oxide adducts of bisphenols, and the like.

The alkylene glycols of 2 to 12 carbon atoms are preferable; examples thereof include ethylene glycol, 1,2-propylene glycol, 1,3-propylene glycol, 1,4-butanediol, and 1,6-hexanediol. Examples of the alkylene ether glycols include diethylene glycol, triethylene glycol, dipropylene glycol, polyethylene glycol, polypropylene glycol, and polytetramethylene ether glycol. Examples of the alicyclic diols include 1,4-cyclohexanedimethanol and hydrogenated bisphenol A. Examples of the alkylene oxide adducts of the alicyclic diols include cycloaliphatic diols added with alkylene oxides such as ethylene oxide, propylene oxide, and butylene oxide. Examples of the bisphenols include bispheonol A, bisphenol F, and bisphenol S. The alkylene oxide adducts of bisphenols include bisphenols added with alkylene oxides such as ethylene oxide, propylene oxide, and butylene oxide.

Among these, preferable are alkylene glycols of 2 to 12 carbon atoms and alkylene oxide adducts of bisphenols; particularly preferable are alkylene oxide adducts of bisphenols and mixture of alkylene oxide adducts of bisphenols and alkylene glycols of 2 to 12 carbon atoms.

The polyols (TO) of trivalent or higher are preferably those having a valency of 3 to 8 or higher; examples thereof are polyvalent aliphatic alcohols of trivalent or higher, polyphenols of trivalent or higher, alkylene oxide adducts of polyphenols of trivalent or higher, and the like. Examples of polyvalent aliphatic alcohols of trivalent or higher include glycerine, trimethylol ethane, trimethylol propane, pentaerythritol, sorbitol, and the like.

Examples of polyphenols of trivalent or higher include trisphenol PA, phenol novolac, cresol novolac, and like.

The alkylene oxide adducts of above-mentioned polyphenols of trivalent or higher include polyphenols of trivalent or higher added with alkylene oxides such as ethylene oxide, propylene oxide, butylene oxide, and the like.

The weight ratio, DIO:TO, of diol (DIO) and polyol (TO) of trivalent or higher is preferably 100:0.01 to 100:10 and more preferably 100:0.01 to 100:1.

Polycarboxylic acid (PC) may be suitably selected according to the purpose; examples thereof include dicarboxylic acids (DIC), polycarboxylic acids (TC) of trivalent or higher, mixtures of dicarboxylic acids (DIC) and polycarboxylic acids of trivalent or higher, and the like.

These may be used alone or in combination of two or more. Among these, dicarboxylic acids (DIC) alone, or mixtures of DICs and a small amount of polycarboxylic acids (TC) of trivalent or higher are preferable.

Examples of dicarboxylic acid include alkylene dicarboxylic acids, alkenylene dicarboxylic acids, aromatic dicarboxylic acids, and the like.

Examples of alkylene dicarboxylic acid include succinic acid, adipic acid, sebacic acid, and the like.

The alkenylene dicarboxylic acids preferably have 4 to 20 carbon atoms; examples thereof include maleic acid, fumaric acid, and the like.

The aromatic dicarboxylic acids have 8 to 20 carbon atoms; examples thereof include phthalic acid, isophthalic acid, terephthalic acid, naphthalenedicarboxylic acid, and the like.

Among these, preferable are alkenylene dicarboxylic acids having 4 to 20 carbon atoms and aromatic dicarboxylic acids having 8 to 20 carbon atoms.

The polycarboxylic acids (TO) of trivalent or higher preferably have a valence of 3 to 8 or more, and which are exemplified by aromatic polycarboxylic acids.

The aromatic polycarboxylic acids preferably have 9 to 20 carbon atoms; examples thereof include trimellitic acid, pyromellitic acid, and the like.

The polycarboxylic acids (PC) may be acid anhydrides or lower alkyl esters selected from dicarboxylic acids (DIC), polycarboxylic acids of trivalent or higher (TC) and mixtures of dicarboxylic acid (DIC) and polycarboxylic acid of trivalent or higher.

Examples of lower alkyl ester include methyl esters, ethyl esters, isopropyl esters, and the like.

The weight ratio, DIC:TC, in mixturs of dicarboxylic acid (DIC) and polycarboxylic acid of trivalent or higher (TC) may be suitably selected according to the purpose; the weight ratio is preferably 100:0.01 to 100:10 and more preferably 100:0.01 to 100:1.

The weight ratio of polyol (PO) and polycarboxylic acid (PC) at the polycondensation reaction may be suitably selected according to the purpose; for example, the equivalent ratio, [OH]/[COOH], of hydroxyl group [OH] of polyol (PO) and carboxyl group [COOH] of polycarboxylic acid (PC) is preferably 2/1 to 1/1 and more preferably 1.5/1 to 1/1, and particularly preferably 1.3/1 to 1.02/1.

The content of polyol (PO) in the isocyanate group-containing polyester prepolymer (A) may be suitably selected according to the purpose; preferably, the content is 0.5% by weight to 40% by weight, more preferably 1% by weight to 30% by weight and particularly preferably 2% by weight to 20% by weight.

In cases where the content is less than 0.5% by weight, the hot offset resistance may deteriorate, making it difficult to simultaneously satisfy both heat resistance/storage stability and low-temperature fixability. In cases where the content is more than 40% by weight, low-temperature fixability may deteriorate.

The polyisocyanates (PICs) may be suitably selected according to the purpose; examples thereof include aliphatic polyisocyanates, alicyclic polyisocyanates, aromatic diusocyanate, aroma-aliphatic diisocyanates, isocyanurates, phenol derivatives thereof, and derivative compounds blocked with oxime or caprolactam. Examples of aliphatic polyisocyanates include tetramethylene diisocyanate, hexamethylene diisocyanate, 2,6-diisocyanate methyl caproate, octamethylene diisocyanate, decamethylene diisocyanate, dodecamethylene diisocyanate, tetradecamethylene diisocyanate, torimethylhexane diisocyanate, tetramethylhexane diisocyanate, and the like. Examples of alicyclic polyisocyanates include isophorone diisocyanate, cyclohexylmethane diisocyanate, and the like. Examples of aromatic diisocyanates include tolylene diisocyanate, diphenylmethane diisocyanate, 1,5-naphtylene diisocyanate, diphenylene-4,4′-diisocyanate, 4,4′-diisocyanato-3,3′-dimethyldiphenyl, 3-methyldiphenylmethane-4,4′-disocyanate, diphenylether-4,4′-diisocyanate, and the like. Examples of aromatic aliphatic diisocyanates include α,α,α′,α′,-tetramethylxylylene diisocyanate, and the like. Examples of isocyanurates include tris-isocyanatoalkyl-isocyanurate, tris-isocyanatocycloalkyl-isocyanurate, and the like.

Preferably, the equivalent mixing ratio, [NCO]/[OH], of isocyanate group [NCO] of polyisocyanate (PIC) to hydrogen group [OH] of active hydrogen group-containing polyester resin such as hydrogen group-containing polyester resin at the reaction, is 5/1 to 1/1, more preferably 4/1 to 1.2/1 and particularly preferably 3/1 to 1.5/1.

When the value of isocyanate group [NCO] is more than 5, the low-temperature fixability may deteriorate, and when less than 1, the offset resistance may deteriorate.

The content of polyisocyanate (PIC) in the isocyanate group-containing polyester prepolymer (A) may be suitably selected according to the purpose. Preferably, the content is 0.5% by weight to 40% by weight, more preferably 1% by weight to 30% by weight, and particularly preferably 2% by weight to 20% by weight.

When the content is less than 0.5% by weight, the hot offset resistance may deteriorate, making it difficult to simultaneously satisfy the heat resistance/storage stability and the low-temperature fixability, and when the content is more than 40% by weight, the low-temperature fixability may deteriorate.

The average number of isocyanate groups contained in one molecule of the isocyanate group-containing polyester prepolymer (A) is preferably 1 or more, more preferably 1.2 to 5, and particularly preferably 1.5 to 4.

When the average number of isocyanate groups is less than 1, the molecular weight of polyester resin (RMPE) modified with the urea-bond-formation group comes to lower and the hot offset resistance may deteriorate.

The average molecular weight (Mw) of the polymer reactive with the active hydrogen group-containing compound, in terms of molecular weight distribution by Gel permeation chromatography (GPC) of tetrahydrofuran (THF) soluble content, is preferably 3,000 to 40,000, and more preferably 4,000 to 30,000. When the average molecular weight (Mw) is less than 3,000, the heat resistance/storage stability may deteriorate and when more than 40,000, the low-temperature fixability may deteriorate.

The molecular weight distribution by gel permeation chromatography (GPC), for example, may be measured as follows.

Firstly, a column is equilibrated inside the heat chamber of 40° C. At this temperature, tetrahydrofuran (THF) as a column solvent is passed through the column at a flow rate of 1 ml/minute, and 50 to 200 μl of sample resin in THF is injected at a concentration of 0.05% by weight to 0.6% by weight, then the measurement is carried out. In the measurement of molecular weight of the sample, a molecular weight distribution of the sample is calculated from a relationship between logarithm values of the analytical curve made from several mono-disperse polystyrene standard samples and counted numbers. It is preferred that the standard polystyrene samples for making analytical curves are preferably ones with a molecular mass of 6×10², 2.1×10², 4×10², 1.75×10⁴, 1.1×10⁵, 3.9×10⁵, 8.6×10⁵, 2×10⁶ and 4.48×10⁶ (by Pressure Chemical Co., Ltd., or Tosoh Corporation) and at least approximately 10 pieces of the standard polystyrene sample are used. A refractive index (RI) detector may be used for the detector.

The weight ratio of the modified polyester resin reactive with the active hydrogen group-containing compound relative to all the binder resin components constituting the toner is preferably 5% by weight to 30% by weight and, more preferably, 10% by weight to 25% by weight. When the weight ratio is less than 5% by weight, the hot offset resistance may deteriorate, making it difficult to simultaneously satisfy the heat resistance/storage stability and the low-temperature fixability, and when the weight ratio is more than 30% by weight, the low-temperature fixability may deteriorate.

The glass transition temperature of the binder resin containing the polyester resin and modified polyester resin is preferably 40° C. or more and 70° C. or less. In cases where the glass transition temperature being less than 40° C., the heat resistance/storage stability of the toner may deteriorate and when more than 70° C., the low-temperature fixability may be insufficient.

<Colorant>

The colorants may be suitably selected according to the purpose; examples thereof include carbon blacks, nigrosine dyes, iron black, Naphthol Yellow S, Hansa Yellow (10G, 5G, G), cadmium yellow, yellow iron oxide, yellow ocher, chrome yellow, Titan Yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, anthracene yellow BGL, isoindolinone yellow, colcothar, red lead oxide, lead red, cadmium red, cadmium mercury red, antimony red, Permanent Red 4R, Para Red, Fiser Red, parachloroorthonitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanine blue, phthalocyanine blue, fast sky blue, indanthrene blue (RS, BC), indigo, ultramarine blue, iron blue, anthraquinone blue, fast violet B, methylviolet lake, cobalt purple, manganese violet, dioxane violet, anthraquinone violet, chrome green, zinc green, chromium oxide, viridian green, emerald green, pigment green B, naphthol green B, green gold, acid green lake, malachite green lake, phthalocyanine green, anthraquinone green, titanium oxide, zinc flower, lithopone, and the like. These can be used alone or in combination of two or more.

The colorant content of the toner may be suitably selected according to the purpose; preferably, it is 1% by weight to 15% by weight, and more preferably 3% by weight to 10% by weight. When it is less than 1% by weight, tinting strength of the toner is lowered, and when it is more than 15% by weight, pigment dispersion is likely to be insufficient in the toner, resulting in degradation of tinting strength or electric properties of the toner.

The colorants may be combined with resins to form masterbatches. Such resins may be suitably selected from known resins according to the purpose; examples thereof include polyesters, polymers of styrene or substituted styrenes, styrene copolymers, polymethyl methacrylates, polybuthyl methacrylates, polyvinyl chlorides, polyvinyl acetates, polyethylenes, polypropylenes, epoxy resins, epoxy polyol resins, polyurethanes, polyamides, polyvinyl butyral, polyacrylic acid resins, rosin, modified rosins, terpene resins, aliphatic or alicyclic hydrocarbon resins, aromatic petroleum resins, chlorinated paraffin, paraffin wax, and the like. These may be used alone or in combination of two or more.

Examples of polymers of styrene or substituted styrenes include polyester resin, polystyrene, poly-p-chlorostyrene, polyvinyl toluene, and the like. Examples of styrene copolymers include styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, styrene-maleic ester copolymers, and the like

The masterbatches may be obtained by mixing or kneading resins for the masterbatch and a colorant with high shear force. In order to improve interaction between colorant and a resin, an organic solvent may be added. In addition, the “flushing process” in which a wet cake of colorant being applied directly is preferable because drying is unnecessary. In the flushing process, a water-based paste containing colorant and water is mixed or kneaded with the resin and an organic solvent so that the colorant moves towards the resin, and that water and the organic solvent are removed. The materials are preferably mixed or kneaded using a triple roll mill and other high-shear dispersing devices.

<Other Ingredients>

The other ingredients may be suitably selected according to the purpose; examples thereof include releasing agents, charge control agents, inorganic particles, flowability enhancers, cleaning improvers, magnetic materials, and the like.

—Releasing Agents—

The releasing agent may be suitably selected according to the purpose. Preferably, a releasing agent has a low melting point of 50° C. to 120° C. The releasing agent having a low melting point works effectively between fixing roller and toner interface as releasing agents dispersed in the binder resin and exhibit effect on high-temperature offset without applying releasing agents such as oils to the fixing rollers.

As the releasing agent, waxes are preferably used. Examples of waxes include vegetable waxes such as carnauba wax, cotton wax, wood wax, rice wax, animal waxes such as honey wax, lanolin, mineral waxes such as ozokelite, selsyn, and petrolatum waxes such as paraffin, microcrystalline, petrolatum. Besides these natural waxes, synthetic hydrocarbon waxes such as Fischer-Tropsh wax, polyethylene wax, synthetic waxes such as esters, ketones, ethers. Other examples of the releasing agent include: aliphatic acid amides such as 12-hydroxystearic acid amide, stearic acid amide, phthalic anhydride imide, chlorinated hydrocarbons; crystalline polymer resin having low molecular weight such as homo polymer or copolymer of polyacrylate such as poly-n-stearyl methacrylate and poly-n-lauryl methacrylate (for example, n-stearyl acrylate-ethyl methacrylate copolymer); and a crystalline polymer of which side chain has long alkyl group. These may be used alone or in combination of two or more.

The melting point of the releasing agent may be suitably selected according to the purpose; preferably, the melting point is 50° C. to 120° C. and, more preferably, 60° C. to 90° C. When the melting point is less than 50° C., the wax may adversely affect heat resistance/storage stability; and when the melting point is above 120° C., it is liable to cause cold offset at fixing processes under the lower temperatures.

The melt viscosity of the releasing agent is, measured at the temperature 20° C. higher than the melting point of the wax, preferably 5 cps to 1,000 cps and, more preferably, 10 cps to 100 cps. In cases where the melt viscosity is less than 5 cps, releasing ability may deteriorate, and when the melt viscosity is more than 1,000 cps, the hot offset resistance and the low-temperature fixability may be improved insufficiently.

The releasing agent content of the toner may be suitably selected according to the purpose; preferably, it is 40% by weight or less and, more preferably, 3% by weight to 30% by weight. When it is more than 40% by weight, the toner flowability may deteriorate.

—Charge Control Agent—

The charge control agent may be suitably selected from known agents according to the purpose. Examples of charge control agent include nigrosine dyes, triphenylmethane dyes, chromium-containing metal complex dyes, chelate molybdate pigment, rhodamine dyes, alkoxy amine, quaternary ammonium salt (including fluorine modified quaternary ammonium salt), alkylamide, phosphorus alone or compounds thereof, tungsten alone or compounds thereof, fluorine-based active agents, salicylic acid metal salts, and metal salts of salicylic acid derivatives. These may be used alone or in combination of two or more.

The charge control agent may be of commercially available ones. Specific examples thereof include nigrosin dye BONTRON 03, quaternary ammonium salt BONTRON-P-51, metal-containing azo dye BONTRON S-34, oxynaphthoic acid metal complex E-82, salicylic metal complex E-84, phenolic condensate E-89 (which are produced by Orient Chemical Industries Ltd.), molybdenum complex with quaternary ammonium salt TP-302 and TP-415 (which are produced by Hodogaya Chemical Co., Ltd.), quaternary ammonium salt copy charge PSY VP2038, triphenylmethane derivatives copy blue PR, quaternary ammonium salt copy charge NEG VP2036, copy charge NX VP434 (which are produced by Hochst), LRA-901, boron complex LR-147 (which are produced by Japan Carlit Co., Ltd.), copper phthalocyanine, perylene, quinacridone, azo pigment, and high-molecular-weight-compounds having sulfonic acid group, carboxyl group, or quaternary ammonium salt group.

The use amount of the charge control agent in the toner is determined depending on types of binder resin, presence of additives used as needed, and toner manufacturing methods including a dispersion method, and therefore cannot be uniquely determined. However, the content of charge control agent is preferably 0.1 parts by weight to 10 parts by weight, and more preferably 0.2 parts by weight to 5 parts by weight based on 100 parts by weight of the binder resin. When the content is less than 0.1 parts by weight, the charge may be uncontrollable; when the content is more than 10 parts by weight, charging ability of the toner becomes excessively significant, which lessens the effect of charge control agent itself and increases electrostatic attraction force with a developing roller, leading to decrease of developer flowability or image density degradation.

—Inorganic Fine Particles—

The inorganic fine particles are preferably used as an external additive to facilitate flowability, developability and chargeability of toner particles.

The inorganic fine particles may be suitably selected from known agents according to the purpose. Examples of the inorganic fine particles include silica, alumina, titanium oxide, barium titanate, magnesium titanate, calcium titanate, strontium titanate, zinc oxide, tin oxide, silica sand, clay, mica, wollastonite, diatomite, chromium oxide, cerium oxide, colcothar, antimony trioxide, magnesium oxide, zirconium oxide, barium sulfate, barium carbonate, calcium carbonate, silicon carbide, silicon nitride or the like. These may be used alone or in combination of two or more.

Such an inorganic fine particle preferably has a primary particle diameter of 5 nm to 2 μm and, more preferably of 5 nm to 500 nm.

The amount of the organic fine particles in the toner is preferably 0.01% by weight to 5.0% by weight based on the toner and, more preferably, 0.01% by weight to 2.0% by weight.

—Flowability Improver—

The flowability improver is an agent applying surface treatment to improve hydrophobic properties, and is capable of inhibiting the degradation of flowability or charging ability under high humidity environment. Specific examples of the flowability improver include a silane coupling agent, a silylation agent, a silane coupling agent having a fluorinated alkyl group, an organotitanate coupling agent, an aluminum coupling agent, silicone oil, modified silicone oil, and the like. It is preferable that the silica and titanium oxide be subjected to surface treatment with such a flowability improver and used as hydrophobic silica and hydrophobic titanium oxide.

—Cleaning Improver—

The cleaning improver is added to the toner to remove the residual developer on a photoconductor or a primary transfer member after transferring. Specific examples of the cleaning improver include fatty acid metal salt such as zinc stearate, calcium stearate, stearic acid, and the like, fine polymer particles formed by soap-free emulsion polymerization, such as fine polymethylmethacrylate particles, fine polyethylene particles, and the like. The fine polymer particles have preferably a narrow particle size distribution. It is preferable that the volume average particle diameter thereof is 0.01 μm to 1 μm.

—Magnetic Material—

The magnetic material is not particularly limited and can be suitably selected from a known magnetic material according to the purpose. Suitable examples thereof are iron powder, magnetite, ferrite, and the like. Among these, one having a white color is preferable in terms of tone.

The toner according to the present invention can be produced by the following preferred method, but the production method is not limited thereto.

The toner production method according to the present invention includes emulsifying or dispersing a toner material solution or a toner material dispersion in an aqueous medium to prepare an emulsified or dispersed liquid, followed by formation of toner particles. More specifically, the method includes the following steps (1) to (6).

(1) Preparation of Toner Material Solution or Toner Material Dispersion

The toner material solution or toner material dispersion is produced by dissolving or dispersing the toner material in an organic solvent.

Materials contained in the toner are not particularly limited as long as they can form toner and may be suitably selected according to the purpose. For example, the toner material includes the first binder resin, and second binder resin according to need, and further active hydrogen group-containing compound and modified polyester (prepolymer) reactive with the active hydrogen group-containing compound according to need, and furthermore other ingredients such as releasing agent, colorant, charge control agent, and the like according to need.

The toner material solution or toner material dispersion is produced by dissolving or dispersing the toner material in an organic solvent. The organic solvent is removed during or after formation of toner particles.

The organic solvent may be suitably selected according to the purpose, provided that the organic solvent allows the toner material to be dissolved or dispersed therein. It is preferable that the organic solvent be a solvent having a boiling point of less than 150° C. in terms of easy removal. Specific examples thereof are toluene, xylene, benzene, carbon tetrachloride, methylene chloride, 1,2-dichloroethane, 1,1,2-trichloroethane, trichloroethylene, chloroform, monochlorobenzene, dichloroethylidene, methylacetate, ethylacetate, methyl ethyl ketone, methyl isobutyl ketone, and the like. Among these solvents, ester-based solvents are preferable, and ethyl acetate is more preferable. These solvents may be used alone or in combination.

The amount of organic solvent may be selected suitably according to the purpose; preferably, the amount is 40 parts by weight to 300 parts by weight, more preferably 60 parts by weight to 140 parts by weight, and particularly preferably 80 parts by weight to 120 parts by weight based on 100 parts by weight of the toner material.

The components in the toner material other than the polymers (prepolymers) reactive with the active hydrogen group-containing compound may be added/mixed in the aqueous medium in preparation of the aqueous medium to be described later, or added in the aqueous medium together with the toner material solution or toner material dispersion when the solution is added in the aqueous medium.

(2) Preparation of Aqueous Medium

The aqueous medium may be suitably selected from known ones, and is exemplified by water, water-miscible solvents, and combinations thereof. Among these, water is particularly preferable.

The water-miscible solvent may be anything, as long as being miscible with water; examples thereof include alcohols, dimethylformamide, tetrahydrofuran, cellosolves, lower ketones, and the like.

Examples of alcohols include methanol, isopropanol, ethylene glycol, and the like. Examples of lower ketones include acetone, methyl ethyl ketone, and the like. These may be used alone or in combination of two or more.

The aqueous medium phase may be prepared, e.g., trough dispersing resin fine particles in the aqueous medium. The amount of resin fine particles added to the aqueous medium may be adjusted suitably according to the purpose; preferably, the amount is 0.5% by weight to 10% by weight.

The resin fine particles may be anything as long as capable of forming an aqueous dispersion in an aqueous medium, and may be suitably selected from known resins according to the purpose. The resin fine particles may be of thermoplastic resins or thermosetting resins; examples thereof include vinyl resins, polyurethane resins, epoxy resins, polyester resins, polyamide resins, polyimide resins, silicone resins, phenol resins, melamine resins, urea resins, aniline resins, ionomer resins, polycarbonate resins, and the like.

These may be used alone or in combination of two or more. Among these, the resin fine particles formed of at least one selected from the vinyl resins, polyurethane resins, epoxy resins, and polyester resins are preferable by virtue of easily producing aqueous dispersion of fine spherical resin particles.

The vinyl resins are polymers in which a vinyl monomer is mono- or co-polymerized. Examples of vinyl resins include styrene-(meth)acrylate ester resins, styrene-butadiene copolymers, (meth)acrylate-acrylic acid ester copolymers, styrene-acrylonitrile copolymers, styrene-maleic anhydride copolymers, styrene-(meth)acrylate copolymers, and the like.

The resin fine particles may be formed of copolymer containing a monomer having at least two or more unsaturated groups.

The monomer having at least two or more unsaturated groups may be selected suitably according to the purpose. Examples of such monomers include sodium salt of sulfate ester of methacrylic acid ethylene oxide adduct (Eleminol RS-30, by Sanyo Chemical Industries, Co., Ltd.), divinylbenzene, 1,6-hexane-diol acrylate, and the like.

The resin fine particles may be formed through known polymerization processes suitably selected according to the purpose, and are preferably produced into an aqueous dispersion of resin fine particles. Examples of preparation processes of the aqueous dispersion include (i) a direct preparation process of aqueous dispersion of the resin fine particles in which, in the case of the vinyl resin, a vinyl monomer as a raw material is polymerized by suspension-polymerization process, emulsification-polymerization process, seed polymerization process or dispersion-polymerization process; (ii) a preparation process of aqueous dispersion of the resin fine particles in which, in the case of the polyaddition or condensation resin such as polyester resin, polyurethane resin, or epoxy resin, a precursor (monomer, oligomer or the like) or solvent solution thereof is dispersed in an aqueous medium in the presence of a dispersing agent, and heated or added with a curing agent so as to be cured, thereby producing the aqueous dispersion of the resin fine particles; (iii) a preparation process of aqueous dispersion of the resin fine particles in which, in the case of the polyaddition or condensation resin such as polyester resin, polyurethane resin, or epoxy resin, a suitably selected emulsifier is dissolved in a precursor (monomer, oligomer or the like) or solvent solution thereof (preferably being liquid, or being liquidized by heating), and then water is added so as to induce phase inversion emulsification, thereby producing the aqueous dispersion of the resin fine particles; (iv) a preparation process of aqueous dispersion of the resin fine particles, in which a resin, previously prepared by polymerization process which may be any of addition polymerization, ring-opening polymerization, polyaddition, addition condensation, or condensation polymerization, is pulverized by means of a pulverizing mill such as mechanical rotation-type, jet-type or the like, and classified to obtain resin fine particles, and then the resin fine particles are dispersed in an aqueous medium in the presence of a suitably selected dispersing agent, thereby producing the aqueous dispersion of the resin fine particles; (v) a preparation process of aqueous dispersion of the resin fine particles, in which a resin, previously prepared by a polymerization process which may be any of addition polymerization, ring-opening polymerization, polyaddition, addition condensation or condensation polymerization, is dissolved in a solvent, the resultant resin solution is sprayed in the form of a mist to thereby obtain resin fine particles, and then the resulting resin fine particles are dispersed in an aqueous medium in the presence of a suitably selected dispersing agent, thereby producing the aqueous dispersion of the resin fine particles; (vi) a preparation process of aqueous dispersion of the resin fine particles, in which a resin, previously prepared by a polymerization process, which may be any of addition polymerization, ring-opening polymerization, polyaddition, addition condensation or condensation polymerization, is dissolved in a solvent, the resultant resin solution is subjected to precipitation by adding a poor solvent or cooling after heating and dissolving, the solvent is removed to thereby obtain resin fine particles, and then the resulting resin fine particles are dispersed in an aqueous medium in the presence of a suitably selected dispersing agent, thereby producing the aqueous dispersion of the resin fine particles; (vii) a preparation process of aqueous dispersion of the resin fine particles, in which a resin, previously prepared by a polymerization process, which may be any of addition polymerization, ring-opening polymerization, polyaddition, addition condensation or condensation polymerization, is dissolved in a solvent to thereby obtain a resin solution, the resin solution is dispersed in an aqueous medium in the presence of a suitably selected dispersing agent, and then the solvent is removed by heating or reduced pressure to thereby obtain the aqueous dispersion of the resin fine particles; (viii) a preparation process of aqueous dispersion of the resin fine particles, in which a resin, previously prepared by a polymerization process, which is any of addition polymerization, ring-opening polymerization, polyaddition, addition condensation or condensation polymerization, is dissolved in a solvent to thereby obtain a resin solution, a suitably selected emulsifier is dissolved in the resin solution, and then water is added to the resin solution so as to induce phase inversion emulsification, thereby producing the aqueous dispersion of the resin fine particles.

When preparing the aqueous dispersion, a dispersant is preferably used according to need at the time of emulsifying and/or dispersing (to be described later) in order to stabilize oil droplets formed from toner material solution or toner material dispersion and sharpen the particle size distribution while yielding a desirable shape.

The dispersant may be selected suitably according to the purpose; examples thereof include surfactants, water-insoluble inorganic dispersants, polymeric protective colloids, and the like. These may be used alone or in combination of two or more. Among these, surfactants are particularly preferable.

Examples of surfactants include anionic surfactants, cationic surfactants, nonionic surfactants, ampholytic surfactants, and the like.

Examples of anionic surfactants include alkylbenzene sulfonic acid salts, α-olefin sulfonic acid salts, phosphoric acid esters, anionic surfactants having fluoroalkyl group and the like. Among these, anionic surfactants having fluoroalkyl group are preferable. Examples of the anionic surfactants having fluoroalkyl group include fluoroalkyl carboxylic acids of 2 to 10 carbon atoms or metal salts thereof, disodium perfluorooctanesulfonylglutamate, sodium-3-[omega-fluoroalkyl (C6 to C11)oxy]-1-alkyl (C3 to C4) sulfonate, sodium-3-[omega-fluoroalkanoyl (C6 to C8)-N-ethylamino]-1-sodium propanesulfonate, fluoroalkyl (C11 to C20) carboxylic acids or metal salts thereof, perfluoroalkyl (C7 to C13) carboxylic acids or metal salts thereof, perfluoroalkyl (C4 to C12) sulfonic acid or metal salt thereof, perfluorooctanesulfonic acid diethanol amide, N-propyl-N-(2-hydroxyethyl)perfluorooctanesulfone amide, perfluoroalkyl (C6 to C10) sulfoneamidepropyltrimethylammonium salts, perfluoroalkyl (C6 to C10)-N-ethylsulfonyl glycin salts, monoperfluoroalkyl(C6 to C16)ethylphosphate ester, and the like. Examples of commercially available surfactants containing fluoroalkyl group are Surflon S-111, S-112 and S-113 (by Asahi Glass Co., Ltd.); Frorard FC-93, FC-95, FC-98 and FC-129 (by Sumitomo 3M Ltd.); Unidyne DS-101 and DS-102 (by Daikin Industries, Ltd.); Megafac F-110, F-120, F-113, F-191, F-812 and F-833 (by Dainippon Ink and Chemicals, Inc.); ECTOP EF-102, 103, 104, 105, 112, 123A, 123B, 306A, 501, 201 and 204 (by Tohchem Products Co., Ltd.); Futargent F-100 and F150 (by Neos Co., Ltd.).

Examples of cationic surfactants include amine salt surfactants, quaternary ammonium salt surfactants, cationic surfactants having fluoroalkyl group and the like. Examples of amine salt surfactants include alkyl amine salts, aminoalcohol fatty acid derivatives, polyamine fatty acid derivatives, imidazoline, and the like. Examples of quaternary ammonium salt surfactants include alkyltrimethyl ammonium salts, dialkyldimethyl ammonium salts, alkyldimethyl benzyl ammonium salts, pyridinium salts, alkyl isoquinolinium salts, benzethonium chloride, and the like. Among the cationic surfactants having fluoroalkyl group, preferably used are primary, secondary or tertiary aliphatic amine acids having fluoroalkyl group, aliphatic quaternary ammonium salts such as perfluoroalkyl (C6 to C10) sulfoneamidepropyl trimethylammonium salt, benzalkonium salts, benzetonium chloride, pyridinium salts, imidazolinium salts, and the like.

Specific examples of commercially available product thereof are Surflon S-121 (by Asahi Glass Co., Ltd.) Frorard FC-135 (by Sumitomo 3M Ltd.), Unidyne DS-202 (by Daikin Industries, Ltd.), Megafack F-150 and F-824 (by Dainippon Ink and Chemicals, Inc.), Ectop EF-132 (by Tohchem Products Co., Ltd.), and Futargent F-300 (by Neos Co., Ltd.).

Examples of nonionic surfactants include fatty acid amide derivatives, polyhydric alcohol derivatives, and the like.

Examples of ampholytic surfactants include alanine, dodecyldi(aminoethyl)glycin, di(octylaminoethyl)glycin, N-alkyl-N,N-dimethylammonium betaine, and the like.

Examples of water-insoluble inorganic dispersant include tricalcium phosphate, calcium carbonate, titanium oxide, colloidal silica, hydroxyapatite, and the like.

Examples of polymeric protective colloid are acids, (meth)acrylic monomers having hydroxyl group, vinyl alcohols or esters thereof, esters of vinyl alcohol and compound having carboxyl group, amide compounds or methylol compounds thereof, chlorides, homopolymers or copolymers having nitrogen atom or heterocyclic rings thereof, polyoxyethylenes, celluloses, and the like.

Examples of acids include acrylic acid, methacrylic acid, α-cyanoacrylic acid, α-cyanomethacrylic acid, itaconic acid, crotonic acid, fumaric acid, maleic acid, maleic anhydride, and the like.

Examples of (meth)acrylic monomers having hydroxyl group include β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycol monoacrylic ester, diethyleneglycol monomethacrylic ester, glycerin monoacrylic ester, glycerin monomethacrylic ester, N-methylol acrylamido, N-methylol methacrylamide, and the like.

Examples of vinyl alcohols or ethers of vinyl alcohol include vinyl methyl ether, vinyl ethyl ether, vinyl propyl ether, and the like.

Examples of ethers of vinyl alcohol and compound having carboxyl group include vinyl acetate, vinyl propionate, vinyl butyrate, and the like.

Examples of amide compound or methylol compound thereof include acryl amide, methacrylic amide, diacetone acrylic amide acid, or methylol thereof, and the like.

Examples of chlorides include acrylic chloride, methacrylic chloride, and the like.

Examples of homopolymers or copolymers having nitrogen atom or heterocyclic rings thereof include vinyl pyridine, vinyl pyrrolidone, vinyl imidazole, ethylene imine, and the like.

Examples of polyoxyethylenes include polyoxyethylene, polyoxypropylene, polyoxyethylene alkylamine, polyoxypropylene alkylamine, polyoxyethylene alkylamide, polyoxypropylene alkylamide, polyoxyethylene nonylphenylether, polyoxyethylene laurylphenylether, polyoxyethylene stearylphenyl ester, polyoxyethylene nonylphenyl ester, and the like.

Examples of celluloses include methyl cellulose, hydroxyethyl cellulose, hydroxypropyl cellulose, and the like.

In the preparation of the dispersion, a dispersing stabilizer may be used as required. The dispersing stabilizer is, for example, an acid-soluble or alkali-soluble compound such as calcium phosphate salt, and the like.

When a modified polyester (prepolymer) reactive with an active hydrogen group-containing compound is included as a binder resin of the solution or dispersion, a catalyst for reaction may be used as necessary. The catalyst is, for example, dibutyltin laurate, dioctyltin laurate, and the like.

(3) Emulsification or Dispersion

In the emulsification or dispersion of the toner material solution or toner material dispersion, the solution or dispersion is preferably dispersed in the aqueous medium while stirring. The method for the dispersion is not limited. Preferable examples of equipment for dispersion include: batch type emulsifiers such as Homogenizer (manufactured by IKA Co., Ltd.), Polytron (manufactured by Kinematica Co. Ltd.), TK Auto Homo Mixer (manufactured by Primix Corp.); continuous emulsifiers such as Ebara Milder (manufactured by Ebara Corp.), TK fillmix, TK Pipeline Homo Mixer (manufactured by Primix Corp.), Colloid Mill (manufactured by Kobelco Eco-Solutions Co., Ltd.), Slasher, Trigonal wet-type mill (manufactured by Mitsui Miike Machinery Co., Ltd.), Cavitron (manufactured by Eurotec Co., Ltd.), and Fine flow mill (manufactured by Pacific Machinery & Engineering Co., Ltd.); high-pressure emulsifiers such as Microfluidizer (manufactured by Mizuho Industrial Co., Ltd.), Nanomizer (manufactured by Nanomizer Co., Ltd.) and APV Gorlin (manufactured by Gaulin Co., Ltd.); membrane emulsifiers such as membrane emulsifier (manufactured by Reica Co., Ltd.); vibration emulsifiers such as Vibro Mixer (manufactured by Reica Co., Ltd.); and ultrasonic emulsifiers such as Ultrasonic Homogenizer (manufactured by Branson Co., Ltd.). Among these, APV Gaulin, Homogenizer, TK Auto Homo Mixer, Ebara Milder, TK fillmix, and TK Pipeline Homo Mixer are preferably used for their capability of realizing uniform particle diameters.

In the case where a modified polyester (prepolymer) reactive with an active hydrogen group-containing compound is included as the first resin of a binder resin of the solution or dispersion, the reaction proceeds at the time of the emulsification or dispersion. The reaction conditions are not particularly limited and may be selected suitably according to a combination of active hydrogen group-containing compound and the polymer reactive with the compound. The reaction time is preferably from 10 minutes to 40 hours and, more preferably, from 2 hours to 24 hours.

(4) Removal of Solvent

The organic solvent is removed from emulsified slurry resulting from emulsification or dispersion. The removal of organic solvent is carried out, for example, by the following methods: (1) the temperature of the reaction system is gradually raised, and the organic solvent in the oil droplets are completely evaporated and removed; (2) emulsified dispersion is sprayed in a dry atmosphere and the water-insoluble organic solvent is completely evaporated and removed from the oil droplets to form toner particles, while aqueous dispersant being evaporated and removed simultaneously.

(5) Washing, Drying, and Classification Once organic solvent is removed, toner particles are formed.

The toner particles are then subjected to washing, drying, and the like, then toner particles may be classified as necessary. The classification is, for example, carried out using a cyclone, decanter, or centrifugal separation thereby removing particles in the solution. Alternatively, the classification may be carried out after toner particles are produced in a form of powder after drying. In the case where a dispersing stabilizer such as an acid-soluble or alkali-soluble compound such as calcium phosphate, and the like is employed, the dispersing stabilizer is dissolved by action of an acid such as hydrochloric acid, and then washed with water to be removed from toner particles.

(6) External Addition of Charge Control Agent, Releasing Agent, etc.

The toner particles thus obtained are mixed with such particles as the releasing agent, charge control agent, and the like which are inorganic fine particles such as silica fine particles or titanium oxide fine particles as required, and mechanical impact is applied thereto, thereby preventing particles such as the releasing agent from falling off the surfaces of the toner particles.

Examples of the method of applying mechanical impact include a method in which impact is applied to the mixture by means of a blade rotating at high speed, and a method in which impact is applied by introducing the mixture into a high-speed flow to cause particles collide with each other or to cause composite particles to collide against an impact board. Examples of a device employed for these method include angmill (manufactured by Hosokawa micron Co., Ltd.), modified I-type mill (manufactured by Nippon Pneumatic Mfg. Co., Ltd.) to decrease pulverization air pressure, hybridization system (manufactured by Nara Machinery Co., Ltd.), kryptron system (manufactured by Kawasaki Heavy Industries, Ltd.), and automatic mortars.

The physical properties such as the shape, size, and the like of the toner according to the present invention are not particularly limited and may be selected suitably according to the purpose. Preferably, the toner has the following volume average particle diameter (Dv), a ratio (Dv/Dn) of volume average particle diameter (Dv) to number average particle diameter (Dn), penetration, low-temperature fixing properties, offset non-occurring temperature, and the like.

The volume average particle diameter (Dv) of the toner is, for example, preferably 3 μm to 8 μm. In the case where the volume average particle diameter is less than 3 μm, the toner of two-component developer is liable to fuse onto carrier surfaces as a result of stirring in the developing unit for a long period, and a one-component developer is liable to cause a filming to a developing roller or fusion to a member such as a blade for reducing a thickness of a toner layer formed onto a developing roller. In the case where the volume average particle diameter is more than 8 μm, an image of high resolution and high quality is rarely obtained, and the mean toner particle diameter may fluctuate after consumption or addition of toner.

The ratio (Dv/Dn) of the volume average particle diameter (Dv) to the number average particle diameter (Dn) is preferably 1.00 to 1.25.

In the case where the ratio (Dv/Dn) is less than 1.00, the toner of a two-component developer is liable to fuse onto carrier surfaces due to stirring in a developing unit for a long-period, thereby degrading a charging ability of the carrier or cleaning properties, and a one-component developer is liable to cause a filming to a developing roller or fusion to a member such as a blade for reducing a thickness of a toner layer formed onto a developing roller. In the case where the ratio is more than 1.30, an image of high resolution and high quality is rarely obtained, and the mean toner particle diameter may fluctuate after consumption or addition of toner.

In the case where the ratio (Dv/Dn) of volume average particle diameter to number average particle diameter falls within a range of 1.00 to 1.25, the toner excels the following properties such as storage stability, low-temperature fixing properties, and hot offset resistance and, particularly, exhibits excellent image glossiness in the case where the toner is used in a full color copier. Thus, in the case of the toner of two-component developer, even when the toner is repeatedly supplied after consumption thereof for a long period, the mean toner particle diameter rarely fluctuate, and even if used (stirred) for long period of time in a developing unit, good and stable developing properties can be obtained. Further, in the case of the toner of one-component developer, there is not much difference of particle diameter even when the toner is repeatedly supplied after consumption thereof, there is no fuse of the toners on a development roller or sticking of toners to blades or other parts due to thinning of the layer of the toner, and even if used (stirred) for a long period of time in a developing unit (image-developer), good and stable developing properties and high quality images can be obtained.

The volume average particle diameter and the ratio (Dv/Dn) can be measured, for example, by means of a particle size analyzer, MultiSizer II, manufactured by Beckmann Coulter Inc.

The penetration is preferably 15 mm or more and, more preferably, preferably 20 mm to 30 mm in accordance with a penetration test (JIS K2235-1991).

In the case where the penetration is less than 15 mm, it is liable to degrade heat resistance/storage stability.

The penetration is measured in accordance with JIS K2235-1991. Specifically, the penetration is measured by filling a toner into a 50 ml glass container, leaving the glass container filled with the toner in a thermostat of 50° C. for 20 hours, sequentially cooling the toner to an ambient temperature, and then carrying out a penetration test thereto. Note that, the higher the penetration is, the more the excellent heat resistance/storage stability the toner has.

As the low-temperature fixing properties of the toner, the lowest fixing temperature is preferably as low as possible, and the offset non-occurring temperature is preferably as high as possible, in view of realizing both lower fixing temperature and prevention of occurrence of the offset. When the lowest fixing temperature is less than 150° C. and the offset non-occurring temperature is 200° C. or more, both the lower fixing temperature and prevention of offset are realized.

The lowest fixing temperature is determined as follows. A transfer sheet is set in an image-forming apparatus, a copy test is carried out, the thus obtained fixed image is scrubbed by pads, and the persistence of the image density is measured. The lowest fixing temperature is determined as a temperature at which the persistence of the image density becomes 70% or more.

The offset non-occurring temperature is measured as follows. A transfer sheet is set in an image-forming apparatus, and the image-forming apparatus is adjusted so as to develop a solid image in each color of yellow, magenta, and cyan, as well as intermediate colors of red, blue, and green, and so as to vary the temperature of a fixing belt. The offset non-occurring temperature is determined as the highest fixing temperature at which offset does not occur.

The coloration of the toner is not particularly limited, and can be suitably selected according to the purpose. For example, the coloration is at least one selected from a black toner, a cyan toner, a magenta toner, and a yellow toner. Each color toner is obtained by suitably selecting the colorant to be contained therein.

(Developer)

The developer in the present invention contains at least the toner of the present invention and further contains other optional ingredients such as carriers described above. The developer is either one-component developer or two-component developer. However, the two-component developer is preferable in view of improved life span when the developer is used with, for example, a high speed printer that complies with improvements in recent information processing speed.

The one-component developers, using the toner of the present invention, may exhibit less fluctuation in toner-particle diameter even after consumption or addition of toner, and also bring about less toner filming on developing rollers or toner fusion onto members such as a blade for reducing a thickness of a toner layer, therefore providing excellent and stable developing property and images over long-term use (stirring) of a developing unit. The two-component developers, using toner of the present invention, may exhibit less fluctuation in the toner particle diameter even after the toner is repeatedly supplied after consumption thereof, and the excellent and stable developing property is maintained after stirring in a developing unit for prolonged periods.

The carrier may be suitably selected according to the purpose; the carrier preferably has a core material and a resin layer on the core material.

The core material may be suitably selected from known ones; examples thereof include manganese-strontium (Mn, Sr) materials and manganese-magnesium (Mn, Mg) materials of 50 emu/g to 90 emu/g, and also highly magnetized materials such as iron powder (100 emu/g or more) and magnetite (75 emu/g to 120 emu/g) in view of ensuring appropriate image density. Weak-magnetizable materials such as copper-zinc (Cu, Zn) materials (30 emu/g to 80 emu/g) are also preferred in view of reducing the shock to the photoconductor the toner ears from, which is advantageous for high image quality. These may be used alone or in combination of two or more.

The core material preferably has a volume average particle size of 10 μm to 150 μm, more preferably 20 μm to 80 μm.

In the case where the average particle size (volume average particle size (D₅₀) is smaller than 10 μm, an increased amount of fine powder is observed in the carrier particle size distribution, and thus magnetization per particle is lowered, which may cause the carrier to fly. In the case where the average particle size is larger than 150 μm, the specific surface area is reduced, which may cause the toner to fly. Therefore, a full color image having many solid parts may not be well reproduced particularly in the solid parts.

The resin material may be suitably selected from known ones according to the purpose; examples thereof include amino resins, polyvinyl resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, copolymers of vinylidene fluoride and acrylic monomer, copolymers of vinylidene fluoride and vinyl fluoride, fluoroterpolymers such as terpolymer of tetrafluoroethylene, vinylidene fluoride and non-fluoride monomer, and silicone resins. These may be used alone or in combination of two or more.

Examples of amino resins include urea-formaldehyde resins, melamine resins, benzoguanamine resins, urea resins, polyamide resins, epoxy resins, and the like. Examples of polyvinyl resins include acrylic resins, polymethylmethacrylate resins, polyacrylonitrile resins, polyvinyl acetate resins, polyvinyl alcohol resins, polyvinyl butyral resins, and the like. Examples of polystyrene resins include polystyrene resins, styrene acryl copolymer resins, and the like. Examples of halogenated olefin resins include polyvinyl chlorides, and the like. Examples of polyester resins include polyethyleneterephthalate resins and polybutyleneterephthalate resins, and the like.

The resin layer may contain, for example, conductive powder, etc. as necessary. Examples of conductive powder include metal powder, carbon black, titanium oxide, tin oxide, zinc oxide, and the like. The average particle diameter of conductive powder is preferably 1 μm or less. When the average particle diameter is more than 1 μm, controlling of the electrical resistance may be difficult.

The resin layer may be formed, for example, by dissolving the silicone resins, etc. in a solvent to prepare a coating solution, uniformly applying the coating solution to the surface of core material by known processes, then drying and baking. Examples of coating processes include immersion, spray, brushing, and the like.

The solvent may be suitably selected according to the purpose; examples thereof include toluene, xylene, methyl ethyl ketone, methyl isobutyl ketone, cellosol-butylacetate, and the like.

The baking may be carried out through external or internal heating. Examples of the baking processes include those by use of fixed electric furnaces, flowing electric furnaces, rotary electric furnaces, burner furnaces, microwave, or the like.

The content of resin layer in the carrier is preferably 0.01% by weight to 5.0% by weight. When the content is less than 0.01% by weight, the resin layer may be formed nonuniformly on the surface of the core material, and when the content is more than 5.0% by weight, the resin layer may become excessively thick to cause granulation between carriers, and carrier particles may be formed nonuniformly.

When the developer is a two-component developer, the content of the carrier in the two-component developer may be selected suitably according to the purpose; preferably, the content is 90% by weight to 98% by weight, more preferably 93% by weight to 97% by weight.

<Process Cartridge>

The process cartridge of the present invention includes at least a latent electrostatic image bearing member for bearing thereon a latent electrostatic image and a developing unit for developing the latent electrostatic image on the latent electrostatic image bearing member using toner to form a visible image, and further includes other units according to need.

The developing unit contains at least a developer container for storing the developer of the present invention and a developer carrier for carrying and transferring the developer stored in the developer container and may further contain a layer-thickness control member for controlling the thickness of carried toner layer.

The process cartridge of the present invention may be detachably mounted on a variety of electrophotographic image forming apparatuses, and is preferably detachably mounted on an image forming apparatus according to the present invention to be described later.

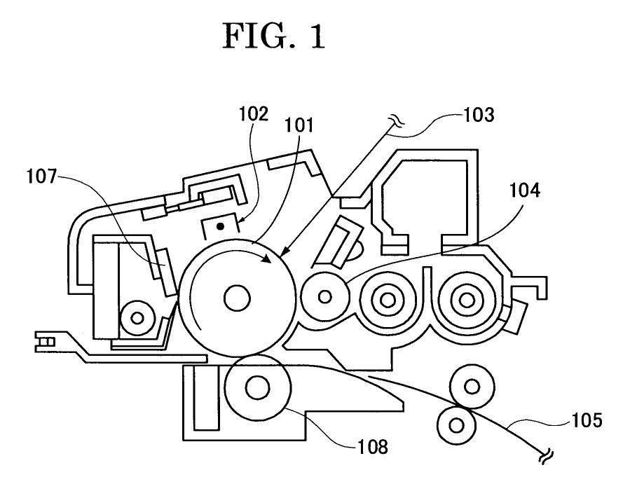

The process cartridge includes, for example as shown in FIG. 1, a built-in latent electrostatic image bearing member 101, a charging unit 102, a developing unit 104, a cleaning unit 107, and a transferring unit 108 and also other members according to need. In FIG. 1, 103 denotes exposure performed by an exposure unit, and 105 denotes a recording medium.

In the image forming process by use of the process cartridge shown in FIG. 1, a latent electrostatic image, corresponding to the exposed image, is formed on the surface of the latent electrostatic image bearing member 101, rotating in the arrow direction, by the charge of the charging unit 102 and the exposure 103 of an exposing unit (not shown). The latent electrostatic image is developed by means of the developing unit 104, the visualized image is then transferred to the recording medium 105 by means of the transferring unit 108 and printed out. Then the latent electrostatic image bearing member surface after the image transfer is cleaned by means of the cleaning unit 107, followed by discharging through a charge-eliminating unit (not shown) and these operations are carried out repeatedly.

(Image Forming Method and Image Forming Apparatus)

An image forming method of the present invention includes a step of forming a latent electrostatic image, a developing step, a transferring step, a fixing step and other steps such as discharging, cleaning, recycling, controlling, as necessary.

An image forming apparatus of the present invention includes a latent electrostatic image bearing member, a latent electrostatic image forming unit, a developing unit, a transferring unit, a fixing unit and other units such as a discharging unit, a cleaning unit, a recycling unit and a control unit as necessary.

The step of forming a latent electrostatic image is one that forms a latent electrostatic image on the latent electrostatic image bearing member. Materials, shapes, structures or sizes, etc. of the latent electrostatic image bearing member (sometimes referred to as “electrophotographic photoconductor”, “photoconductor”, or “latent electrostatic image bearing member”) may be selected suitably from known ones and the latent electrostatic image bearing member is preferably of a drum shape. The materials for the latent electrostatic image bearing member are inorganic materials such as amorphous silicon and selenium, and organic materials such as polysilane and phthalopolymethine, for example. Among these materials, amorphous silicon is preferred by virtue of longer operating life.

A latent electrostatic image may be formed, for example, by uniformly charging a surface of the latent electrostatic image bearing member, and irradiating imagewisely, which may be performed in the latent electrostatic image forming unit.

The latent electrostatic image forming unit includes at least a charger which uniformly charges the surface of the latent electrostatic image bearing member, and an exposure unit which exposes the surface of the latent electrostatic image bearing member imagewise.

The charging may be performed, for example, by applying a voltage to the surface of the latent electrostatic image bearing member using the charger.

The charger may be selected suitably according to the purpose; examples thereof include known contact chargers equipped with conductive or semi-conductive roller, brush, film or rubber blade and non-contact chargers using corona discharges such as corotron and scorotron.

It is preferable that the chargers be placed in contact with or not in contact with the latent electrostatic image bearing member and that a direct and alternating voltages are superimposed and applied to charge the surface of the latent electrostatic image bearing member.

Further, it is preferable that the chargers be a charge roller which is allocated near but without contacting the latent electrostatic image bearing member through a gap tape and that the direct and alternating voltages are superimposed and applied to charge the surface of the latent electrostatic image bearing member.

Exposures may be performed by exposing the surface of the latent electrostatic image bearing member imagewise using the exposure unit, for example.

The exposure unit may be suitably selected according to the purpose as long as capable of exposing imagewise on the surface of the latent electrostatic image bearing member charged by the charger. Examples of the exposure unit include copying optical systems, rod lens array systems, laser optical systems and liquid crystal shutter optical systems.

In the present invention, the back-exposure method may be adopted in which the latent electrostatic image bearing member is exposed imagewise from the back side.

—Developing Step and Developing Unit—

The developing step is one where a latent electrostatic image is developed using toner or developer of the present invention to form a visible image.

The visible image may be formed, for example, by developing a latent electrostatic image using toner or developer, which may be performed by the developing unit.

The developing unit may be anything as long as capable of developing an image by using toner or developer, and may be selected from known developing units suitably. For example, a preferable developing unit contains a toner or developer and includes a developing device which can impart the toner or the developer in a contact or non-contact manner to a latent electrostatic image.

The developing device may be of dry-type or wet-type, and may also be of monochrome or multi-color. As a preferable example, the developing device has an agitator that frictions and agitates the toner or developer for charging and a rotatable magnet roller.

In the developing device, the toner and the carrier may, for example, be mixed and stirred together. The toner is charged by friction, and forms a magnetic brush on the surface of the rotating magnet roller. Since the magnet roller is arranged near the latent electrostatic image bearing member (photoconductor), a part of the toner constructing the magnetic brush formed on the surface of the magnet roller is moved toward the surface of the latent electrostatic image bearing member (photoconductor) due to the force of electrical attraction. As a result, the latent electrostatic image is developed by the use of toner, and a visible toner image is formed on the surface of the latent electrostatic image bearing member (photoconductor).

—Transferring Step and Transferring Unit—

The transferring step is one transferring the visible image to a recording medium. It is preferred that the transferring step is carried out in such a way that the visible images are primary-transferred on an intermediate transfer member, then the visible images are secondary-transferred from the intermediate transfer member to the recording medium; it is more preferred that toners of two or more colors, preferably full-color toners are employed, and the transferring step is carried out by way of the first transfer step in which visual images are transferred on the intermediate transfer member to form complex transferred images and the second transfer step in which the complex transferred images are transferred to the recording medium.

The transfer of the visible images may be performed by charging the latent electrostatic image bearing member (photoconductor) using a transfer-charging device, which may be performed by the transferring unit. The transferring unit preferably includes a primary transferring unit that transfers visible images to an intermediate transfer member to form complex transferred images and a secondary transferring unit that transfers the complex transferred images to the recording medium.

The intermediate transfer member may be suitably selected according to the purpose from known transfer members; favorable examples include a transfer belt.

The transferring unit (primary transferring unit and secondary transferring unit) preferably includes at least a transferring device that strips and charges the visible images formed on the latent electrostatic image bearing member (photoconductor) to the side of the recording medium. The transferring unit may exist one or plural.

Examples of the transferring device include corona transferring devices on the basis of corona discharge, transfer belts, transfer rollers, pressure transfer rollers and adhesive transferring devices.

Also, the recording medium is not particularly limited and may be selected suitably from known recording media (recording paper).

The fixing step is one that fixes visible images transferred to the recording medium using a fixing unit. The fixing may be carried out for each color upon transferred onto the recording medium, or simultaneously after all colors are laminated.

The fixing unit may be suitably selected from known heating and pressing units according to the purpose; examples thereof include combinations of heating rollers and pressing rollers, and combinations of heating rollers, pressing rollers, and endless belts.

In a preferable aspect, the fixing unit is a heat fixing unit which includes a heat application member having a heater, a film contacting the heart application member, and a pressure application member for pressure contacting the heat application member through the film and fixes an unfixed image on a recording medium while the recording medium is passed between the film and pressure application member. The heating temperature in the heating and pressing units is preferably 80° C. to 200° C.

In addition, in the present invention, known optical fixing units may be used along with or in place of the fixing step and fixing unit, according to the purpose.

The charge-eliminating step is one that applies a discharge bias to the latent electrostatic image bearing member, which may be performed by a charge-eliminating unit.

The charge-eliminating unit may be suitably selected from known ones as long as it can apply a discharge bias to the latent electrostatic image bearing member; examples thereof include discharge lamps.

The cleaning step is one in which residual toner on the latent electrostatic image bearing member is removed, which may be performed by a cleaning unit.

Any conventional cleaning unit may be used as long as capable of removing residual toners on the latent electrostatic image bearing member and may be selected suitably from known ones; examples thereof include magnetic brush cleaners, electrostatic brush cleaners, magnetic roller cleaners, blade cleaners, brush cleaners, and web cleaners.

The recycling step is one in which the toner, removed in the cleaning step, is recycled for use in the developing, which may be performed by a recycling unit.

The recycling unit may be suitably constructed from known transport units.

The controlling step is one in which the respective processes are controlled, which may be carried out by a controlling unit. Any conventional controlling units capable of controlling the performance of each unit may be selected suitably according to the purpose. Examples thereof include instruments such as sequencers or computers, etc.

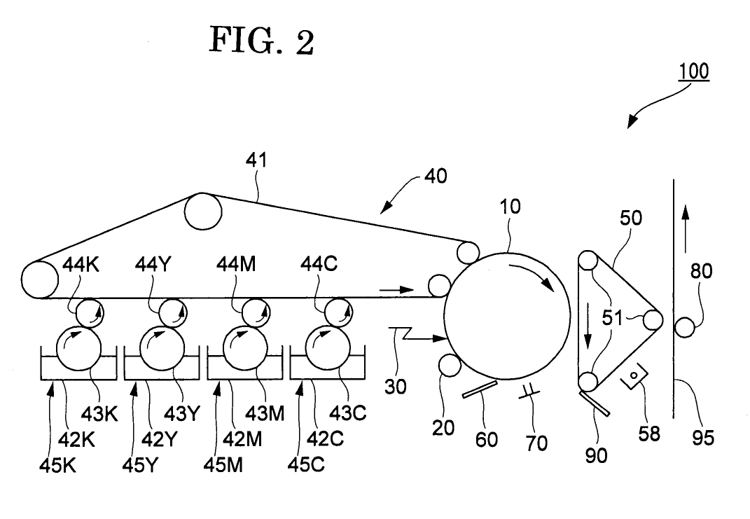

An aspect of the image forming method using the image forming apparatus of the present invention will be described with reference to FIG. 2. An image forming apparatus 100 shown in FIG. 2 is equipped with a photoconductor drum 10 (hereafter referred to as “photoconductor 10”) as the latent electrostatic latent electrostatic image bearing member, a charge roller 20 as the charging unit, an exposure device 30 as the exposure unit, a developing device 40 as the developing unit, an intermediate transfer member 50, a cleaning unit 60 as the cleaning means having a cleaning blade, and a discharge lamp 70 as a charge-eliminating unit.

The intermediate transfer member 50 is an endless belt being extended over the three rollers 51 placed inside the belt and designed to be moveable in arrow direction in FIG. 2. A part of three rollers 51 function as a transfer bias roller capable of applying a specified transfer bias (primary transfer bias), to the intermediate transfer member 50. The cleaning blade 90 for intermediate transfer member is placed near the intermediate transfer member 50, and a transfer roller 80, as a transferring unit capable of applying a transfer bias for transferring (secondary transferring) a visible image (toner image) onto a recording medium 95, is placed face to face with the intermediate transfer member 50. In the surrounding area of the intermediate transfer member 50, a corona charger 58 for supplying an electrical charge to the visible image on the intermediate transfer belt 50 is placed between contact area of the photoconductor 10 and the intermediate transfer member 50, and contact area of the intermediate transfer member 50 and recording medium 95 in the rotational direction of the intermediate transfer member 50.

The developing device 40 is constructed with a developing belt 41 as a developer carrier, a black developing unit 45K, yellow developing unit 45Y, magenta developing unit 45M and cyan developing unit 45C disposed, together in the surrounding area of developing belt 41. The black developing unit 45K is equipped with a developer container 42K, a developer feeding roller 43K, and a developing roller 44K. The yellow developing unit 45Y is equipped with a developer container 42Y, a developer feeding roller 43Y, and a developing roller 44Y. The magenta developing unit 45M is equipped with a developer container 42M, a developer feeding roller 43M, and a developing roller 44M. The cyan developing unit 45C is equipped with a developer container 42C, a developer feeding roller 43C, and a developing roller 44C. The developing belt 41 is an endless belt and is extended between several belt rollers as rotatable, and the part of developing belt 41 is in contact with the photoconductor 10.

For example, the charge roller 20 charges the photoconductor 10 evenly in the image forming apparatus 100 shown in FIG. 2. The exposure device 30 exposes imagewise on the photoconductor 10 and forms a latent electrostatic image. The latent electrostatic image formed on the photoconductor drum 10 is then developed with the toner fed from the developing device 40 to form a visible image (toner image). The visible image (toner image) is then primary transferred onto the intermediate transfer member 50 by a voltage applied from the roller 51 and is secondary transferred onto the transfer paper 95. As a result, a transfer image is formed on the transfer paper 95. The residual toner on the photoconductor 10 is removed by the cleaning unit 60 and the charge built up over the photoconductor 10 is temporarily removed by the discharge lamp 70.

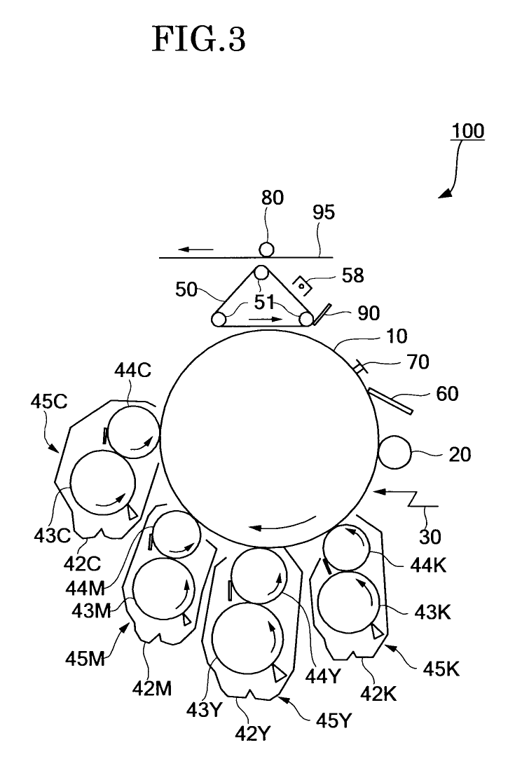

Another aspect for implementing the image forming method according to the present invention performed by the image forming apparatuses will be described with reference to FIG. 3. An image forming apparatus 100 as shown in FIG. 3 has the same construction as the image forming apparatus 100 shown in FIG. 2 except that the developing belt 41 is not equipped and the black developing unit 45K, the yellow developing unit 45Y, the magenta developing unit 45M and the cyan developing unit 45C are placed in the surrounding area directly facing the photoconductor 10 and achieves the same effect as the image forming apparatus 100 shown in FIG. 2. The reference numbers used in FIG. 3 correspond to those used in FIG. 2.

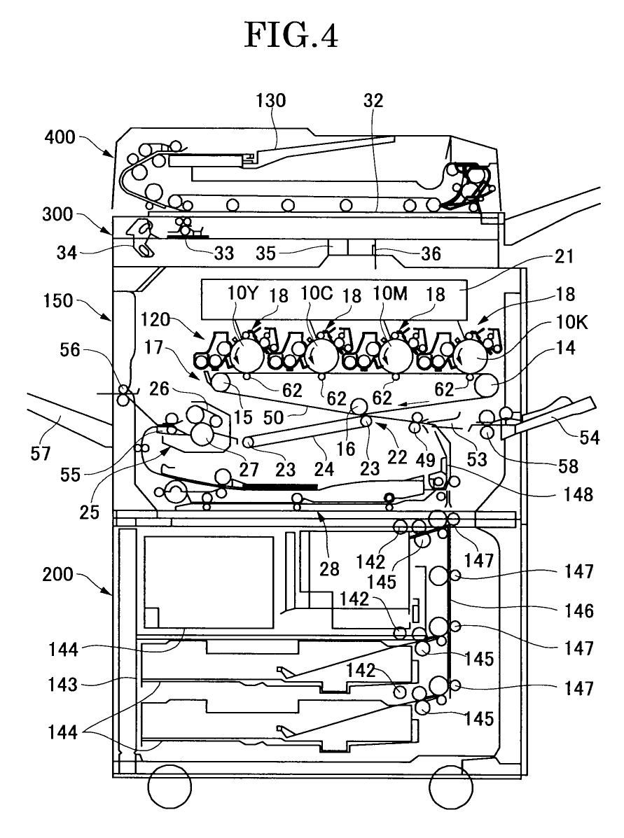

Still another aspect for implementing the image forming method according to the present invention performed by the image forming apparatuses will be described with reference to FIG. 4. A tandem image-forming apparatus shown in FIG. 4 is a tandem color-image-forming apparatus. The tandem image-forming apparatus includes a copying machine main body 150, a paper feeder table 200, a scanner 300, and an automatic document feeder (ADF) 400.

The copying machine main body 150 contains an endless-belt intermediate transfer member 50. The intermediate transfer member 50 is wound around support rollers 14, 15, and 16 and is configured to rotate in a clockwise direction in FIG. 4. There is disposed a cleaning unit 17 for the intermediate transfer member 50 adjacent to the support roller 15. The cleaning unit 17 is capable of removing a residual toner on the intermediate transfer member 50. Above the intermediate transfer member 50 wound around the support rollers 14 and 15, four image-forming units 18 of yellow, cyan, magenta, and black are arrayed in parallel in a conveyance direction of the intermediate transfer member 50 to thereby constitute a tandem developing unit 120. There is also disposed an exposing device 21 adjacent to the tandem developing unit 120. A secondary transfer unit 22 is disposed on the opposite side of the intermediate transfer member 50 to where the tandem developing unit 120 is disposed. The secondary transfer unit 22 includes a secondary transferring belt 24 of an endless belt, which is wound around a pair of rollers 23. The secondary transfer unit 22 is configured so that the recording medium (transfer sheet) conveyed on the secondary transferring belt 24 contacts with the intermediate transfer member 50. Adjacent to the secondary transfer unit 22, there is disposed an image-fixing device 25. The image-fixing device 25 includes a fixing belt 26 which is an endless belt, and a pressurizing roller 27 which is disposed so as to contact against the fixing belt 26.

In the tandem image-forming apparatus, a sheet reverser 28 is disposed adjacent to the secondary transfer unit 22 and the image-fixing device 25. The sheet reverser 28 is configured to reverse a transfer sheet in order to form images on the both sides of the transfer sheet.

Full-color image-formation (color copy) is formed by means of the tandem developing unit 120 in the following manner. Initially, a document is placed on a document platen 130 of the automatic document feeder (ADF) 400. Alternatively, the automatic document feeder 400 is opened, the document is placed on a contact glass 32 of the scanner 300, and the automatic document feeder 400 is closed to press the document.

At the time of pushing a start switch (not shown), the document placed on the automatic document feeder 400 is transported onto the contact glass 32. In the case where the document is initially placed on the contact glass 32, the scanner 300 is immediately driven to operate a first carriage 33 and a second carriage 34. Light is applied from a light source of the first carriage 33 to the document, and reflected light from the document is further reflected toward the second carriage 34. The reflected light is further reflected by a mirror of the second carriage 34 and passes through an image-forming lens 35 into a read sensor 36 to thereby read the color document (color image). The read color image is interrupted to image information of black, yellow, magenta and cyan.

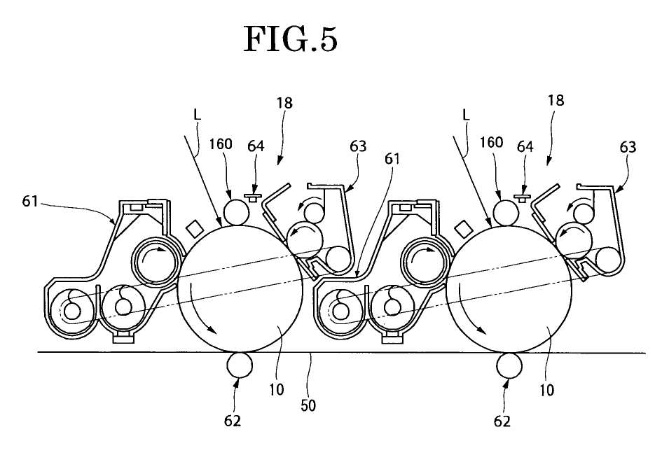

Each of black, yellow, magenta, and cyan image information is transmitted to respective image-forming units 18 (black image-forming unit, yellow image-forming unit, magenta image-forming unit, and cyan image-forming unit) of the tandem developing device 120, and then toner images of black, yellow, magenta, and cyan are separately formed in each image-forming unit 18. With respect to each of the image-forming units 18 (black image-forming unit, yellow image-forming unit, magenta image-forming unit, and cyan image-forming unit) of the tandem developing device 120, as shown in FIG. 5, there are disposed a photoconductor 10 (a photoconductor for black 10K, a photoconductor for yellow 10Y, a photoconductor for magenta 10M, or a photoconductor for cyan 10C), a charger 160 which uniformly charges the photoconductor 10, an exposure unit which exposes (L in FIG. 5) the photoconductor 10 based on each color image information to thereby form a latent electrostatic image corresponding to each color image on the photoconductor 10, an developing unit 61 which develops the latent electrostatic image with the corresponding color toner (a black toner, a yellow toner, a magenta toner, or a cyan toner) to form a toner image of each color, a transfer charger 62 for transferring the toner image to the intermediate transfer member 50, a cleaning unit 63, and a charge eliminating unit 64. Accordingly, each mono-color images (a black image, a yellow image, a magenta image, and a cyan image) are formed based on the corresponding color-image information. Thus obtained black toner image formed on the photoconductor for black 10K, yellow toner image formed on the photoconductor for yellow 10Y, magenta toner image formed on the photoconductor for magenta 10M, and cyan toner image formed on the photoconductor for cyan 10C are sequentially transferred (primary transfer) onto the intermediate transfer member 50 which is rotated by means of the support rollers 14, 15 and 16. These toner images are superimposed on the intermediate transfer member 50 to form a composite color image (color transferred image).

One of feeding rollers 142 of the feeder table 200 is selectively rotated, sheets (recording sheets) are ejected from one of multiple feeder cassettes 144 in a paper bank 143 and are separated by a separation roller 145 one by one into a feeder path 146, are transported by a transport roller 147 into a feeder path 148 in the copying machine main body 150 and are bumped against a resist roller 149. Alternatively, one of the feeding rollers 142 is rotated to ejected sheets (recording sheets) from a manual-feeding tray 54, and the sheets are separated by a separation roller 145 one by one into a feeder path 53, transported one by one and then bumped against the resist roller 49. Note that, the resist roller 49 is generally earthed, but it may be biased for removing paper dust of the sheets. The resist roller 49 is rotated synchronously with the movement of the composite color image on the intermediate transfer member 50 to transport the sheet (recording sheet) into between the intermediate transfer member 50 and the secondary transferring unit 22, and the composite color image is transferred (secondary transferred) onto the sheet (recording sheet) by action of the secondary transferring unit 22. After transferring the toner image, the residual toner on the intermediate transfer member 50 is cleaned by means of the cleaning unit 17 for intermediate transfer member.

The sheet (recording sheet) onto which the color-image has been transferred is transported by the secondary transferring unit 22 into the image-fixing device 25, is applied with heat and pressure in the image-fixing device 25 to fix the composite color image (color transferred image) to the sheet (recording sheet). Thereafter, the sheet (recording sheet) changes its direction by action of a switch blade 55, is ejected by an ejecting roller 56 and is stacked on an output tray 57. Alternatively, the sheet changes its direction by action of the switch blade 55 into the sheet reverser 28, turns the direction, is transported again to the transfer position, subjected to an image formation on the back surface thereof. The sheet bearing images on both sides thereof is then ejected with assistance of the ejecting roller 56, and is stacked on the output tray 57.

According to the present invention, it is possible to solve the problems of the related arts and to provide a toner capable of achieving high image density and simultaneously satisfying both the fixability and storage stability even when a resin containing a polylactic acid as a constituent is used as a binder resin, a developer using the toner, and an image forming method.

### EXAMPLES

The present invention will be explained more specifically with reference to Examples. However, the scope of the present invention is not limited to the following Examples.

In the following Examples and Comparative Examples, the measurements of weight-average molecular weight of a polyester resin, content rate of the isocyanate group (NCO %), acid value, hydroxyl group value, and glass transition temperature (Tg) were carried out as follows.

### <Measurement of Weight-Average Molecular Weight>

The weight-average molecular weight of polyester resin was measured by gel permeation chromatography (GPC) under the following conditions.

Instrument: GPC-150C (manufactured by Waters Corp.)

Column: KF801 to 807 (trademark, manufactured by Shodex)

Temperature: 40° C.

Solvent: tetrahydrofuran (THF)

Flow rate: 1.0 mL/min

Sample: 0.1 ml of sample solution with a concentration of 0.05 to 0.6%

Based on the molecular weight distribution of the polyester resin measured under the above conditions, a molecular weight calibration curve of a monodisperse polystyrene standard sample was used to calculate the weight-average molecular weight of the polyester resin. Note that, in the case of the isocyanate-terminal modified polyester resin, a sample in which n-dibutylamine was added in a molar amount three times the mol amount of the isocyanate group existing in the polyester resin to block the isocyanate terminal was used.

<Measurement of Content Rate of Isocyanate Group (NCO %)>

The content rate of isocyanate group (NCO %) was measured by a method according to JIS K1603. Specifically, 2 g of modified polyester was precisely weighed and 5 ml of dried toluene was added immediately to completely dissolve the sample. Thereafter, all 5 ml of 0.1M n-dibutylamine/toluene solution was added using a pipette, followed by slow stirring for 15 minutes. Subsequently, 5 ml of isopropanol was added, followed by stirring, and then the resultant mixture was subjected to potentiometric titration using 0.1M ethanol-hydrochloric acid standard solution. A consumed amount of dibutylamine was calculated from the obtained titration value to thereby calculate the content rate of the isocyanate group.

<Measurement Method of Acid Value and Hydroxyl Group Value>

The acid value (AV) and hydroxyl group value (OHV) were determined by the following procedure. In the case where the sample was not dissolved, a solvent such as dioxane or THF was used.

Measurement device: automatic potentiometric titrator DL-53 Titrator (manufactured by Mettler-Toledo International Inc.)

Electrode: DG113-SC (manufactured by Mettler-Toledo International Inc.)

Analysis software: LabX Light Version 1.00.000

Device correction: using a mixed solvent of 120 ml of toluene and 30 ml of ethanol

Measurement temperature: 23° C.

Measurement conditions were as follows:

### Stir

### Speed [%]: 25

### Time [s]: 15

EQP titration

### Titrant/Sensor

### Titrant: CH₃ONa

Concentration [mol/L]: 0.1

### Sensor: DG115

Unit of measurement: mV
Predispensing: to volume
Volume [ml]: 1.0
Wait time [s]: 0
Titrant addition: Dynamic
dE (set) [mV]: 8.0
dV (min) [mL]: 0.03
dV (max) [mL]: 0.5
Measure mode: Equilibrium controlled
dE [mV]: 0.5
dt [s]: 1.0
t (min) [s]: 2.0
t (max) [s]: 20.0

### Recognition

### Threshold: 100.0

Steepest jump only: No

### Range: No

### Tendency: None

### Termination

At maximum volume [ml]: 10.0
At potential: No
At slope: No
After number EQPs: Yes
n=1
comb. Termination conditions: No

### Evaluation

### Procedure: Standard

### Potential 1: No

### Potential 2: No

Stop for reevaluation: No

—Measurement Method of Acid Value—

The acid value was measured by a method according to JIS K0070-1992 as follows.

Sample preparation: 0.5 g of toner (0.3 g of ethyl acetate soluble component thereof) was added to 120 ml of toluene, and the mixture is stirred for about 10 hours at room temperature (23° C.). 30 ml of ethanol is further added to the mixture to prepare a sample liquid.

The measurement can be carried out by the abovementioned device. Specific measurement method is as follows.

The sample liquid was titrated with a standardized N/10 potassium hydroxide alcohol solution. On the basis of the consumption of the alcohol-potassium solution, the acid value was determined according to the following calculation:

Acid value=KOH(ml)×N×56.1/weight of sample

where N represents the factor of (N/10) KOH.

—Measurement Method of Hydroxyl Group Value—

The hydroxyl group value was measured by a method according to JIS K0070-1966 as follows. 0.5 g of a sample was precisely weighed and fed to a 100 ml volumetric flask, and 5 ml of an acetylating agent was precisely added thereto. Thereafter, the mixture was heated for 1 to 2 hours in a bath at a temperature of from 95° C. to 105° C. Then, the flask was took out of the bath and subjected to cooling. Water was then added to the flask, and then the flask was shaken so that acetic anhydride is decomposed. The flask was put into the bath again and heated for 10 minutes or more so that the acetic anhydride is completely decomposed. After subjected to cooling, the inner wall of the flask was washed out with an organic solvent. The organic solvent was titrated with a standardized N/2 potassium hydroxide ethyl alcohol solution, using the above-mentioned electrode to obtain the hydroxyl group value.

<Glass Transition Temperature (Tg)>

The glass transition temperature (Tg) was determined according to the following procedure. As a measurement device, TA-60WS and DSC-60 (both manufactured by Shimadzu Corporation) were used. The measurement conditions were as follows.

### [Measurement Conditions]

Sample container: aluminum sample pan (having a cover)

Sample amount: 5 mg

Reference: aluminum sample pan (10 mg of alumina)

Atmosphere: Nitrogen gas (flow rate of 50 ml/min)

Temperature Conditions

Starting temperature: 20° C.

Temperature rising speed: 10° C./min

Finishing temperature: 150° C.

Holding time: None

Temperature decreasing speed: 10° C./min

Finishing temperature: 20° C.

Holding time: None

Temperature rising speed: 10° C./min

Finishing temperature: 150° C.

The measurement result was analyzed with a data analysis software TA-60 version 1.52 (manufactured by Shimadzu Corporation). A peak temperature was determined with a peak analysis function of the software by analyzing a DrDSC curve (i.e., differential curve of DSC curve) obtained in the second temperature rising scan, within a temperature range of from 5° C. lower to 5° C. higher than a temperature at which the maximum peak is observed in the lowest temperature. Then, a maximum endothermic temperature was determined with a peak analysis function of the software by analyzing a DSC curve within a temperature range of from 5° C. lower to 5° C. higher than the peak temperature determined above. The maximum endothermic temperature represents the glass transition temperature (Tg).

### Synthesis Examples 1 to 11

### Synthesis of Resins 1 to 11

701 parts by weight of 1,2-propylene glycol, 716 parts by weight of terephthalic acid dimethyl ester, 180 parts by weight of adipic acid, and 3 parts by weight of tetrabutoxytitanate (as a condensation catalyst), were placed into a reaction vessel equipped with a cooling pipe, a stirrer and a nitrogen gas inlet tube, allowing reaction to take place for 8 hours at 180° C. under nitrogen gas stream, followed by reaction for 4 hours at 230° C. Further, reaction was carried out under reduced pressure of 5 mmHg to 20 mmHg and, when the softening point reached 150° C., the reaction product was taken out. The taken out reaction product was cooled and pulverized to obtain “intermediate polyester (1)”.

The intermediate polyester (1) thus obtained had a number-average molecular weight (Mn) of 2,000, weight-average molecular weight (Mw) of 8,500, acid value of 19 mgKOH/g, and hydroxyl group value of 43 mgKOH/g.

Subsequently, 100 parts by weight in total of the “intermediate polyester resin (1)”, L-lactide, and D-lactide were placed into an autoclave reaction vessel equipped with a thermometer and a stirrer in a ratio shown in the following table 1 and, further, 1 part by weight of titanium terephthalate was placed into the vessel, allowing polymerization for 6 hours at 160° C. after nitrogen substitution to synthesize resins (1) to (11).

TABLE 1

| | L-lactide | D-lactide | Intermediate polyester (1) |
|---|---|---|---|
| Resin (1) | 0 | 83 | 17 |
| Resin (2) | 83 | 0 | 17 |
| Resin (3) | 67 | 0 | 33 |
| Resin (4) | 50 | 0 | 50 |
| Resin (5) | 75 | 8 | 17 |
| Resin (6) | 80 | 3 | 17 |
| Resin (7) | 50 | 17 | 33 |
| Resin (8) | 42 | 8 | 50 |
| Resin (9) | 83 | 17 | 0 |
| Resin (10) | 67 | 33 | 0 |
| Resin (11) | 100 | 0 | 0 |

unit: parts by weight

### Synthesis Example 12

### Synthesis of Resin (12)

67 parts by weight of bisphenol A ethyleneoxide (2 mol) adduct, 84 parts by weight of bisphenol A propionoxide (3 mol) adduct, 274 parts by weight of terephthalic acid, and 2 parts by weight of dibutyltin oxide were placed into a reaction vessel with a cooling pipe, a stirrer, and a nitrogen gas inlet tube, allowing reaction for 8 hours at 230° C. under normal pressure. Subsequently, the reaction liquid was reacted for 5 hours under reduced pressure of 10 mmHg to 15 mmHg, whereby resin (12) was obtained.

The resin (12) thus obtained had a number-average molecular weight (Mn) of 2,100, weight-average molecular weight of 5,600, and glass transition temperature (Tg) of 55° C.

### Synthesis Example 13

### Synthesis of Modified Polyester Resin (1)

150 parts by weight of L-lactide, 50 parts by weight of D-lactide, and 100 parts by weight of the “intermediate polyester (1)” were reacted in a reaction vessel with a cooling pipe, a stirrer, and a nitrogen gas inlet tube for 8 hours at 160° C. under normal pressure to synthesize “intermediate polyester (2)”.

2,000 parts by weight of the “intermediate polyester (2)” was prepared and heated at 110° C. under reduced pressure of 3 mmHg to dehydrate it for 1 hour. Subsequently, 457 parts by weight of isophorone diisocyanate (IPDI) was added to allow reaction for 10 hours at 110° C., whereby modified polyester resin (1) having an isocyanate group at its terminal was obtained. The modified polyester resin (1) thus obtained had a free isocyanate content of 3.4%, glass transition temperature (Tg) of 620° C., and acid value of 20 mgKOH/g.

### Synthesis Example 14

### Synthesis of Modified Polyester Resin (2)

682 parts by weight of bisphenol A ethyleneoxide (2 mol) adduct, 81 parts by weight of bisphenol A propionoxide (2 mol) adduct, 283 parts by weight of terephthalic acid, 22 parts by weight of trimellitic anhydride, and 2 parts by weight of dibutyltin oxide were placed into a reaction vessel with a cooling pipe, a stirrer, and a nitrogen gas inlet tube, allowing reaction for 8 hours at 230° C. under normal pressure. Subsequently, the reaction liquid was reacted for 5 hours under reduced pressure of 10 mmHg to 15 mmHg, whereby “intermediate polyester (3)” was obtained.

The “intermediate polyester (3)” thus obtained had a number-average molecular weight (Mn) of 2,100, weight-average molecular weight (Mw) of 9,600, glass transition temperature (Tg) of 55° C., acid value of 0.5 mgKOH/g, and hydroxyl group value of 49 mgKOH/g.

Subsequently, 411 parts by weight of the “intermediate polyester (3)”, 89 parts by weight of isophorone diisocyanate, and 500 parts by weight of acetic ether were placed into a reaction vessel with a cooling pipe, a stirrer, and a nitrogen gas inlet tube, allowing reaction for 5 hours at 100° C. to synthesize modified polyester resin (2).

The modified polyester resin (2) thus obtained had a free isocyanate content of 1.60% and solid content concentration of 50% by weight (150° C., after leaving for 45 minutes).

—Preparation of Masterbatch (MB)—

1,000 parts by weight of water, 540 parts by weight of carbon black (“Printex 35”; manufactured by Degussa; DBP oil absorption amount: 42 ml/100 g; pH 9.5), and 1,200 parts of the resin (12) were mixed by means of Henschel Mixer (manufactured by Mitsui Mining Co., Ltd.). The mixture was kneaded at 150° C. for 30 minutes by a two-roller mill, cold-rolled, and milled by a pulverizer (manufactured by Hosokawa micron Co., Ltd.), to thereby prepare a masterbatch.

—Synthesis of Ketimine—

Into a reaction vessel equipped with a stirring rod and a thermometer were poured 30 parts by weight of isophoronediamine and 70 parts by weight of methyl ethyl ketone, followed by reaction at 50° C. for 5 hours to thereby synthesize a ketimine compound (the active hydrogen group-containing compound).

The thus obtained ketimine compound (the active hydrogen group-containing compound) had an amine value of 423 mg KOH/g.

—Preparation of Resin Particle Dispersion—

Into a reaction vessel equipped with a stirring rod and a thermometer were poured 683 parts by weight of water, 11 parts by weight of sodium salt of sulfuric acid ester of ethylene oxide adduct of methacrylic acid Eleminol RS-30 (manufactured by Sanyo Chemical Industries Ltd.), 139 parts by weight of styrene, 138 parts by weight of methacrylic acid, and 1 part by weight of ammonium persulfate, and the mixture was then stirred at 400 rpm for 15 minutes to thereby obtain a white emulsion. The emulsion was heated to 75° C. and was allowed to react for 5 hours. Then, 30 parts of a 1% aqueous solution of ammonium persulfate was added to the reaction mixture, followed by aging at 75° C. for 5 hours, to thereby obtain an aqueous dispersion (resin particle dispersion A1) of vinyl resin (a copolymer of styrene-methacrylic acid-sodium salt of sulfate ester of methacrylic acid-ethylene oxide adduct).

The volume-average particle diameter of the resin particle dispersion A1 thus obtained, which was measured using a particle size distribution analyzer (LA-920 manufactured by Horiba, Ltd.), was 0.15 μm. A part of the resin particle dispersion A1 was dried to isolate the resin component. The resin component thus obtained had a glass transition temperature (Tg) of 154° C.

An opaque liquid (resin particle dispersion) was prepared by mixing and stirring 784 parts by weight of water, 136 parts by weight of the previously-obtained resin particle dispersion A1, and 80 parts by weight of 48.5% by weight aqueous solution of sodium dodecyldiphenylether disulfonate (Eleminol MON-7 manufactured by Sanyo Chemical Industries, Co., Ltd.).

—Preparation of Aqueous Medium—

300 parts by weight of ion-exchanged water, 300 parts by weight of the resin dispersion, and 0.2 parts by weight of dodecylbenzenesulfonic acid were mixed and stirred until uniformly dissolved to prepare an aqueous medium phase.

### Examples 1 to 10 and Comparative Examples 1 to 6

### Production of Toner Base Particles

In a beaker, the first binder resin, second binder resin, and modified polyester resin were placed in a ratio shown in Table 2, and 130 parts by weight of acetic ether was added to the mixture, followed by stirring until dissolved to obtain resin solution.

Next, 10 parts by weight of carnauba wax (molecular weight=1,800, acid value=2.5 mgKOH/g and penetration=1.5 mm (40° C.)) and 10 parts by weight of the masterbatch were placed and a material solution was prepared by using a bead mill (“Ultra Visco Mill” by Imex Co., Ltd.) with a condition of a liquid feed rate of 1 kg/hr, disc circumferential velocity of 6 m/s, 0.5 mm zirconia beads packed to 80% by volume, and 3 passes. Subsequently, 2.7 parts by weight of ketimine was added to the material solution followed by dissolution to prepare a solution or dispersion liquid of toner material.

Subsequently, 150 parts by weight of the aqueous medium was put in a container and stirred by using a TK homomixer (manufactured by Primix Corp.) with a rotating speed of 12,000 rpm. Next, 100 parts by weight of the solution or dispersion liquid of toner material was added to the aqueous medium and mixed for 10 minutes to prepare an emulsified or dispersed liquid (emulsion slurry).

Next, 100 parts by weight of the emulsion slurry was placed into a flask equipped with stirrer and thermometer and the solvent was removed at 30° C. for 12 hours while stirring with a stirring circumferential velocity of 20 m/min. Subsequently, after filtering 100 parts by weight of the dispersion slurry under the reduced pressure, 100 parts by weight of ion-exchanged water was added to a filter cake and filtered after mixing by using a TK homomixer at a rotating speed of 12,000 rpm for 10 minutes. 300 parts by weight of ion-exchanged water was added to the obtained filter cake and filtered twice after mixing by using a TK homomixer at a rotating speed of 12,000 rpm for 10 minutes.

20 parts by weight of 10% aqueous solution of sodium hydroxide was added to the obtained filter cake and filtered under a reduced pressure after mixing by using a TK homomixer at a rotating speed of 12,000 rpm for 30 minutes. 300 parts by weight of ion-exchanged water was added to the obtained filter cake and filtered after mixing by using a TK homomixer at a rotating speed of 12,000 rpm for 10 minutes. 300 parts by weight of ion-exchanged water was added to the obtained filter cake and filtered twice after mixing by using a TK homomixer at a rotating speed of 12,000 rpm for 10 minutes. 20 parts by weight of 10% hydrochloric acid was further added to the obtained filter cake and filtered after mixing by using a TK homomixer at a rotating speed of 12,000 rpm for 10 minutes. Finally, 300 parts by weight of ion-exchanged water was added to the obtained filter cake and filtered twice after mixing by using a TK homomixer at a rotating speed of 12,000 rpm for 10 minutes to obtain a final filter cake. The obtained filter cake was then dried by means of a circulating air dryer at 45° C. for 48 hours and sieved through a sieve of 75 μm mesh, whereby toner base particles of Examples 1 to 10 and Comparative Examples 1 to 3 were obtained.

Note that in Comparative Examples 4 to 6, the binder resin was not sufficiently dissolved at the stage when the resin solution was placed to prevent granulation of toner particles.

TABLE 2

| | First binder resin | | Second binder resin | |
|---|---|---|---|---|
| | | Modified | | Modified |
| | Any of Resins (1) | polyester | | polyester |
| | to (11) | resin (1) | Resin (12) | resin (2) |
| Example 1 | Resin (1) 50 | — | 40 | 10 |
| Example 2 | Resin (2) 40 | 10 | 50 | — |
| Example 3 | Resin (3) 70 | — | 20 | 10 |
| Example 4 | Resin (4) 70 | 10 | 20 | — |
| Example 5 | Resin (5) 50 | — | 35 | 15 |
| Example 6 | Resin (6) 50 | — | 40 | 10 |
| Example 7 | Resin (7) 90 | 10 | — | — |
| Example 8 | Resin (8) 90 | 10 | — | — |
| Example 9 | Resin (7) 80 | 20 | — | — |
| Example 10 | Resin (8) 80 | 20 | — | — |
| Comp. Ex. 1 | Resin (9) 90 | 10 | — | — |
| Comp. Ex. 2 | Resin (10) 95 | 5 | — | — |
| Comp. Ex. 3 | Resin (10) 50 | — | 40 | 10 |
| Comp. Ex. 4 | Resin (11) 95 | 5 | — | — |
| Comp. Ex. 5 | Resin (1) 90 | — | — | 10 |
| Comp. Ex. 6 | Resin (3) 90 | 10 | — | — |

unit: parts by weight

In Table 2 Examples 1 to 6 and Comparative Examples 1 to 5 respectively correspond to Examples and Comparative Examples according to the second embodiment of the present invention described below.

The second embodiment of the present invention is directed to a toner that comprises a binder resin and a colorant and that is prepared in an aqueous medium, the binder resin containing a first binder resin and a second binder resin, wherein the binder resin is formed of a polymer having a polyester skeleton, the first binder resin is obtained by block copolymerization of a polyester skeleton A in which at least a constituent unit in which CH₃—C*—H(—OH)(COOH) is dehydration condensed is contained in a repeated structure and a polyester skeleton B in which a constituent unit in which CH₃—C*—H(—OH)(COOH) is dehydration condensed is not contained in a repeated structure, and wherein an weight ratio Y (%) of the first binder resin in all binder resin components and an optical isomer ratio X (%) (monomer equivalent) satisfy the following relationships:

(1) Y≦−1.5X+200, (2) 80<X≦100

where X %=|X (L-type)−X (D-type)| where X (L-type) denotes a ratio (%) of L-type (lactic acid monomer equivalent) and X (D-type) denotes a ratio (%) of D-type (lactic acid monomer equivalent)) in the constituent unit in which CH₃—C*—H(—OH)(COOH) is dehydration condensed.

Examples 7 to 10 and Comparative Examples 1-4, and 6 respectively correspond to Examples and Comparative Examples according to the first embodiment of the present invention described below.

The first embodiment of the present invention is directed to a toner that comprises a binder resin and a colorant, the toner prepared in an aqueous medium, wherein the binder resin is a polymer having a polyester skeleton, the polyester skeleton of the polymer is obtained by block copolymerization of a polyester skeleton A in which at least a constituent unit in which CH₃—C*—H(—OH)(COOH) is dehydration condensed is contained in a repeated structure and a polyester skeleton B in which a constituent unit in which CH₃—C*—H(—OH)(COOH) is dehydration condensed is not contained in a repeated structure, and an optical isomer ratio X (%) (monomer equivalent) is 80% or less, where the optical isomer ratio X (%)=|X (L-type)−X (D-type)| where X (L-type) denotes a ratio (%) of L-type (lactic acid monomer equivalent) and X (D-type) denotes a ratio (%) of D-type (lactic acid monomer equivalent)) in the constituent unit in which CH₃—C*—H(—OH)(COOH) is dehydration condensed.

—External Additive Treatment—

1.0 part by weight of hydrophobized silica (“H2000” manufactured by Clariant (Japan) K.K.) was mixed as an external additive with 100 parts by weight of the obtained “toner base particles” of Examples 1 to 10 and Comparative Examples 1 to 3 using Henschel Mixer (manufactured by Mitsui Mining Co., Ltd.) for 30 seconds at a peripheral speed of 30 m/s followed by resting for one minute. This procedure was repeated for five cycles. The resultant mixture was then allowed to pass through a sieve of 35 μm mesh. Thus, toner of Examples 1 to 10 and Comparative Examples 1 to 3 were obtained.

—Production of Carrier—

100 parts by weight of a silicone resin (SR2411 manufactured by Dow Corning Corp.), 5 parts by weight of γ-(2-aminoethyl) aminopropyl trimethoxysilane, and 10 parts by weight of carbon black were added to 100 parts by weight of toluene. The mixture was dispersed by a homo mixer for 20 minutes to prepare a coating layer forming liquid. Then, 1,000 parts by weight of particulate spherical magnetite having a particle diameter of 50 μm were coated with the above coating liquid using a fluidized bed type coating apparatus to produce a magnetic carrier.

—Production of Developer—

5 parts of each of the toner of Examples 1 to 10 and Comparative Examples 1 to 3 which had been subjected to the above external additive treatment and 95 parts by weight of the carrier were mixed together using a ball mill to produce two-component developers of Examples 1 to 10 and Comparative Examples 1 to 3.

<Weight Ratio Y % of First Binder Resin in Binder Resin Components>

With respect to Examples 1 to 10 and Comparative Examples 1 to 3, the weight ratio of the first binder resin in all binder resin components was calculated based on the total amount of the prepared binder resin in the toner. The results are shown in Tables 3 and 4.

<Optical Isomer Ratio X (%)>

With respect to Examples 1 to 10 and Comparative Examples 1 to 3, the optical isomer ratio X (%) (lactic acid monomer equivalent)=|X (L-type)−X (D-type)| (where X (L-type) denotes a ratio (%) of L-type (lactic acid monomer equivalent) and X (D-type) denotes a ratio (%) of D-type (monomer equivalent)) in the constituent unit in which R—C*—H(—OH)(COOH) constituting the first binder resin is dehydration condensed was calculated. The results are shown in Tables 3 and 4.

More specifically, the optical isomer ratio X (%) was determined as follows. A polymer or toner that has a polyester skeleton is added to a mixture solvent consisting of pure water, 1 mol/l sodium hydroxide solution and isopropyl alcohol. The mixture is then heated to 70° C. and stirred for hydrolysis, followed by filtration for removal of solids and by addition of sulfuric acid for neutralization to give an aqueous solution containing L-lactic acid and/or D-lactic acid that have been produced by decomposition of the polyester. The aqueous solution is subjected to high-performance liquid chromatography (HPLC) on a Sumichiral OA-5000 column, a chiral ligand-exchange column available from Sumika Chemical Analysis Service, Ltd., Japan, to obtain both the peak area S (L) derived from L-lactic acid and peak area S (D) derived from D-lactic acid. Using these peak areas it is possible to find the optical isomer ratio X as follows:

X(L-type) %=100×S(L)/(S(L)+S(D))

X(D-type) %=100×S(D)/(S(L)+S(D))

Optical isomer ratio X%=|X(L-type) %−X(D-type) %|

With respect to the obtained developers, (a) image density, (b) heat resistance/storage stability, and (c) fixability were measured in the manner as described below. The results are shown in Tables 3 and 4.

(a) Image Density

A solid image with the deposited developer amount of 1.00±0.05 mg/cm² was formed on copy sheets (Type 6000 <70W>, manufactured by Ricoh Co., Ltd.) using a tandem color image forming apparatus (Imagio Neo 450 manufactured by Ricoh Co., Ltd.) at a surface temperature of a fixing roller of 160±2° C. The image densities of 6 randomly chosen points in the obtained solid image were measured using a spectrometer (938 SpectroDensitometer manufactured by X-Rite Co., Ltd.) followed by evaluation based on the following evaluation criteria. Note that the image density value was obtained by taking the mean of the measured values of the six points.

[Evaluation Criteria]

A: 2.0 or more

B: 1.70 or more and less than 2.0

C: less than 1.70

(b) Heat Resistance/Storage Stability (Penetration)

The penetration was measured by filling each toner into a 50 ml glass container, leaving the glass container filled with the toner in a thermostat bath of 50° C. for 24 hours, cooling the toner to 24° C., and then carrying out a penetration test (JIS K2235-1991) thereto. Note that, the higher the penetration is, the more the excellent heat resistance/storage stability the toner has. In the case where the penetration is less than 5 mm, a problem is likely to occur.

[Evaluation Criteria]

A: 25 mm or more

B: 15 mm or more and less than 25 mm

C: 5 mm or more and less than 15 mm

D: less than 5 mm

(c) Fixability

Using a modified image forming apparatus (Copier MF-200 by Ricoh Co., Ltd.), in which a Teflon (Trademark) roller was used as a fixing roller and the fixing section was modified, solid toner images with the deposited toner amount of 0.85±0.1 mg/cm² were produced on sheets of a paper TYPE 6200 (regular paper) from Ricoh and a copy paper <135> (thick transfer paper) from NBS Ricoh while changing the temperature of a fixing belt. The highest fixing temperature used herein is the temperature of the fixing belt at which hot offset does not occur in the regular paper. Further, the lowest fixing temperature was measured using the thick transfer paper. The lowest fixing temperature used herein is the temperature of the fixing belt at which the residual rate of the image density was 70% or more when the fixed image was rubbed with a pad.

[Evaluation Criteria]

—Highest Fixing Temperature—

A: 190° C. or more

B: 190° C. to 180° C.

C: 180° C. to 170° C.

D: 170° C. or less

—Lowest Fixing Temperature—

A: 135° C. or less

B: 135° C. to 145° C.

C: 145° C. to 155° C.

D: 155° C. or more

TABLE 3

| | | | | | Fixability | |
|---|---|---|---|---|---|---|
| | | | | heat | | Lowest |
| | | | | resistance/ | Highest | fixing |
| | | | Image | storage | fixing | tem- |
| | Y % | X % | density | stability | temperature | perature |
| Example 1 | 46.8 | 100 | A | A | B | B |
| Example 2 | 46.8 | 89 | A | B | A | B |
| Example 3 | 65.5 | 100 | A | A | B | A |
| Example 4 | 74.8 | 96 | A | B | B | B |
| Example 5 | 46.8 | 84 | A | A | A | A |
| Example 6 | 46.8 | 90 | A | B | A | B |
| Comparative | — | 63 | B | A | C | C |
| Example 1 | | | | | | |
| Comparative | — | 31 | B | C | B | C |
| Example 2 | | | | | | |
| Comparative | — | 34 | C | C | B | C |
| Example 3 | | | | | | |
| Comparative | — | 96 | — | — | — | — |
| Example 4 | | | | | | |
| Comparative | 93.5 | 97 | — | — | — | — |
| Example 5 | | | | | | |

TABLE 4

| | | | | | Fixability | |
|---|---|---|---|---|---|---|
| | | | | heat | | Lowest |
| | | | | resistance/ | Highest | fixing |
| | | | Image | storage | fixing | tem- |
| | Y % | X % | density | stability | temperature | perature |
| Example 7 | 93.5 | 54 | A | B | B | B |
| Example 8 | 93.5 | 61 | A | B | B | B |
| Example 9 | 93.5 | 52 | A | B | A | B |
| Example 10 | 93.5 | 59 | A | B | A | B |
| Comparative | — | 63 | B | A | C | C |
| Example 1 | | | | | | |
| Comparative | — | 31 | B | C | B | C |
| Example 2 | | | | | | |
| Comparative | — | 34 | C | C | B | C |
| Example 3 | | | | | | |
| Comparative | — | 96 | — | — | — | — |
| Example 4 | | | | | | |
| Comparative | 93.5 | 92 | — | — | — | — |
| Example 6 | | | | | | |

As can be seen from the results shown in Tables 3 and 4, the toner of Examples 1 to 8 using a binder resin obtained by block copolymerization of a polyester skeleton having, in a repeated structure, a constituent unit in which CH₃—C*—H(—OH)(COOH) is dehydration condensed and a polyester skeleton in which a constituent unit in which CH₃—C*—H(—OH)(COOH) is dehydration condensed is not contained in a repeated structure exhibited a satisfactory organic solvent solubility allowing the toner particles to be formed in an aqueous medium.

Compared to the toner of Comparative Examples 1 and 2 in which only the resin having a single polylactic acid (not a block copolymer thereof) as a constituent unit, the toner of Examples 1 to 8 exhibited high image density, high heat resistance/storage stability and excellent fixability. Thus, it was confirmed that the basic characteristics of the toner having polylactic acid as a constituent unit could be improved.

Further, Comparative Example 3 is an example in which not a block copolymer but a resin composed only of polylactic acid skeleton is used as the first binder resin and this first binder resin is used in combination of polyester of the second binder resin so as to improve the toner basic characteristics. In this case, the two binder resins were unevenly distributed on the toner surface due to their low compatibility, with the result that the toner basic characteristics themselves could not be ensured.

The toners of Comparative Examples 4 and 5 are examples in which polylactic acid of only one type optical isomer (L-type or D-type) is used to form the toner. In this case, the solubility into an organic resin was significantly decreased due to high crystallinity, with the result that desired toner particles could not be formed in an aqueous medium.

Comparative Example 5 does not satisfies the requirement Y≦−1.5X+220, thus resulting failure to obtain toner particle. This corresponds to Comparative Example of the second embodiment of the present invention.

Moreover, the optical isomer ratio X of in Comparative Example 6 exceeds 80%, resulting in failure to obtain toner particles. This corresponds to Comparative Example of the first embodiment of the present invention.

According to the toner of the present invention, both the fixability and storage stability of the toner can be satisfied, as well as compatibility with the second binder resin can be increased thus obtaining a uniform resin composition in the toner and, therefore, the toner is suitably used in a formation process of a high quality electrophotographic image. The developer, toner container, process cartridge, image forming apparatus, and image forming method using the toner according to the present invention can widely be applied to a full-color copying machine, a full-color laserprinter, and a full-color fax machine for normal paper, which use a direct or indirect electrophotographic multi-color image developing process.

What is claimed is:

1. A toner comprising: a binder resin and a colorant, the toner prepared in an aqueous medium,
wherein the binder resin is a polymer having a polyester skeleton,
the polyester skeleton of the polymer is obtained by block copolymerization of a polyester skeleton A in which at least a constituent unit in which CH₃—C*—H(—OH)(COOH) is dehydration condensed is contained in a repeated structure and a polyester skeleton B in which a constituent unit in which CH₃—C*—H(—OH)(COOH) is dehydration condensed is not contained in a repeated structure, and
an optical isomer ratio X (%) (monomer equivalent) is 80% or less, where the optical isomer ratio X (%)=|X (L-type)−X (D-type)| where X (L-type) denotes a ratio (%) of L-type (lactic acid monomer equivalent) and X (D-type) denotes a ratio (%) of D-type (lactic acid monomer equivalent)) in the constituent unit in which CH₃—C*—H(—OH)(COOH) is dehydration condensed.

2. The toner according to claim 1, wherein the weight ratio of the polyester skeleton A in the binder resin is 20% or more and less than 80%.

3. The toner according to claim 1, wherein the binder resin which is a block copolymer of the polyester skeleton A and polyester skeleton B is obtained by ring-opening polymerization of cyclic ester.

4. The toner according to claim 1, wherein the binder resin contains a modified polyester resin reactive with an active hydrogen group-containing compound.

5. The toner according to claim 4, wherein the modified polyester resin reactive with the active hydrogen group-containing compound is a modified polyester resin having an isocyanate group at its terminal.

6. The toner according to claim 1, wherein reaction at the time of particle formation is one of urea reaction and urethane reaction.

7. The toner according to claim 4, wherein the weight ratio of the modified polyester resin reactive with the active hydrogen group-containing compound relative to all the binder resin components constituting the toner is 5% by weight to 30% by weight.

8. The toner according to claim 1, wherein the glass transition temperature of the binder resin containing the polyester resin and modified polyester resin is 40° C. or more and 70° C. or less.

9. A toner comprising: a binder resin and a colorant, the toner prepared in an aqueous medium,
wherein the binder resin contains a first binder resin composed of a polymer having a polyester skeleton and a second binder resin,
the first binder resin is obtained by block copolymerization of a polyester skeleton A in which at least a constituent unit in which CH₃—C*—H(—OH)(COOH) is dehydration condensed is contained in a repeated structure and a polyester skeleton B in which a constituent unit in which CH₃—C*—H(—OH)(COOH) is dehydration condensed is not contained in a repeated structure, and
a weight ratio Y % of the first binder resin in all binder resin components and an optical isomer ratio X (%) (monomer equivalent) satisfy the following conditions: Y≦−1.5X+220, 80<X≦100,
where the optical isomer ratio X (%)=|X (L-type)−X (D-type)| where X (L-type) denotes a ratio (%) of L-type (lactic acid monomer equivalent) and X (D-type) denotes a ratio (%) of D-type (lactic acid monomer equivalent)) in the constituent unit in which CH₃—C*—H(—OH)(COOH) constituting the first binder resin is dehydration condensed.

10. The toner according to claim 9, wherein the weight ratio of the polyester skeleton A in the binder resin is 20% or more and less than 80%.

11. The toner according to claim 9, wherein the binder resin which is a block copolymer of the polyester skeleton A and polyester skeleton B is obtained by ring-opening polymerization of cyclic ester.

12. The toner according to claim 9, wherein the binder resin contains a modified polyester resin reactive with an active hydrogen group-containing compound.

13. The toner according to claim 12, wherein the modified polyester resin reactive with the active hydrogen group-containing compound is a modified polyester resin having an isocyanate group at its terminal.

14. The toner according to claim 9, wherein reaction at the time of particle formation is at least one of urea reaction and urethane reaction.

15. The toner according to claim 12, wherein the weight ratio of the modified polyester resin reactive with the active hydrogen group-containing compound relative to all the binder resin components constituting the toner is 5% by weight to 30% by weight.

16. The toner according to claim 9, wherein the glass transition temperature of the binder resin containing the polyester resin and modified polyester resin is 40° C. or more and 70° C. or less.

17. A developer comprising: a toner and a carrier,
wherein the toner comprises a binder resin and a colorant and is granulated in an aqueous medium, wherein the binder resin is a polymer having a polyester skeleton, the polyester skeleton of the polymer is obtained by block copolymerization of a polyester skeleton A in which at least a constituent unit in which CH₃—C*—H(—OH)(COOH) is dehydration condensed is contained in a repeated structure and a polyester skeleton B in which a constituent unit in which CH₃—C*—H(—OH)(COOH) is dehydration condensed is not contained in a repeated structure, and an optical isomer ratio X (%) (monomer equivalent) is 80% or less, where the optical isomer ratio X (%)=|X (L-type)−X (D-type)| where X (L-type) denotes a ratio (%) of L-type (lactic acid monomer equivalent) and X (D-type) denotes a ratio (%) of D-type (lactic acid monomer equivalent)) in the constituent unit in which CH₃—C*—H(—OH)(COOH) is dehydration condensed.

18. An image forming method comprising:
forming a latent electrostatic image on a latent electrostatic image bearing member;
developing the latent electrostatic image to form a visible image using a toner;
transferring the visible image onto a recording medium; and
fixing the visible image to the recording medium,
wherein the toner comprises a binder resin and a colorant and is granulated in an aqueous medium, wherein the binder resin is a polymer having a polyester skeleton, the polyester skeleton of the polymer is obtained by block copolymerization of a polyester skeleton A in which at least a constituent unit in which CH₃—C*—H(—OH)(COOH) is dehydration condensed is contained in a repeated structure and a polyester skeleton B in which a constituent unit in which CH₃—C*—H(—OH)(COOH) is dehydration condensed is not contained in a repeated structure, and an optical isomer ratio X (%) (monomer equivalent) is 80% or less, where the optical isomer ratio X (%)=|X (L-type)−X (D-type)| where X (L-type) denotes a ratio (%) of L-type (lactic acid monomer equivalent) and X (D-type) denotes a ratio (%) of D-type (lactic acid monomer equivalent)) in the constituent unit in which CH₃—C*—H(—OH)(COOH) is dehydration condensed.
